(19) United States
(12) Patent Application Publication
(10) Pub. No.: US 2007/0203936 A1
(43) Pub. Date: Aug. 30, 2007

(54) Method and apparatus for supporting development of broker program, and computer product

(75) Inventors: Yoshitaka Honishi, Kawasaki (JP); Takashi Motoda, Kawasaki (JP); Atsushi Kitamura, Kawasaki (JP); Yasunari Tateiwa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/434,474

(22) Filed: May 15, 2006

(30) Foreign Application Priority Data
Feb. 27, 2006 (JP) 2006-050375

(51) Int. Cl. G06F 7/00

(52) U.S. Cl. 707/102

(57) ABSTRACT

A data-type expressing unit expresses, when a data type of a parameter for an application is out of a range of data type supported by an interface definition language, a predetermined data type of the interface definition language corresponding to the data type of the application in the interface definition language, based on information on the data type of the application. A file generating unit generates an interface-definition-language file in which information required for generating a broker program is expressed in the interface definition language using the data type of the interface definition language expressed by the data-type expressing unit.

### BACKGROUND OF THE INVENTION

1. Field of the Invention

The present invention relates to a technology for supporting development of a broker program.

2. Description of the Related Art

Middleware platform technology, such as common object request broker architecture (CORBA), realizes interaction between applications described in various programming languages. Specifically, the applications and a broker program are installed in a middleware platform, and the broker program brokers an interaction between the applications. In order to create the broker program, an interface information definition file is required. In the interface information definition file, interface information of an application, such as a data type definition of a parameter for the application, is described in a particular description language.

“Catalog of OMG IDL/Language Mappings Specifications” (http://www.omg.org/technology/documents/idl2x_spec_catalog.htm, searched as of Feb. 6, 2006) discloses a CORBA specification that requires a broker program referred to as a stub or a skeleton. In order to create the stub or the skeleton, an interface definition language (IDL) file is required. In the IDL file, interface information of an application is described in IDL.

Japanese Patent Application Laid-Open No. H11-296359 discloses a program for automatically generating IDL files from source files of applications described in various programming languages. Specifically, the program includes a standard correspondence table including data types of parameters for applications described in various programming languages corresponding to data types supported by IDL. The program generates IDL files based on the standard correspondence table.

However, if a data type of a parameter for an application is not included among those supported by IDL, the program does not include a standard correspondence table for the application. In this case, the developer of the application needs to define an IDL data type according to a new description, and create a special correspondence table. If the special correspondence table is registered in the program in advance, the program can generate an IDL file for the application based on the special correspondence table.

For example, assume that a parameter for an application described in a common business oriented language (COBOL) includes a data type defining a packed decimal with four integer numbers and three decimal numbers. This data type is not included among those supported by IDL, and therefore, the program does not include a standard correspondence table for the application. Thus, the developer of the application defines an IDL data type as unsigned long and CBL_PACK_{—}9_{—}4V9_{—}3 according to a new description, creates a special correspondence table including this definition, and registers the special correspondence table in the program in advance. Accordingly, the program generates an IDL file for the application based on the special correspondence table.

Thus, with the conventional technology, when a data type of a parameter for an application is not included among those supported by IDL, a developer of the application needs to take the trouble of preparing a special correspondence table, in order to create a broker program. Accordingly, a burden on the developer will be heavier. Moreover, the developer needs to manage special correspondence tables prepared for different applications.

Thus, there is a need for a technology capable of reducing the amount of work required of a developer for creating a broker program, when a data type of a parameter for an application is not included among those supported by IDL.

### SUMMARY OF THE INVENTION

It is an object of the present invention to at least partially solve the problems in the conventional technology.

An apparatus according to one aspect of the present invention is for supporting development of a broker program configured to be installed in a middleware platform that realizes an interaction between plural applications described in various programming languages. The apparatus includes a data-type expressing unit that expresses, when a data type of a parameter for the application is out of a range of data type supported by an interface definition language, a predetermined data type of the interface definition language corresponding to the data type of the application in the interface definition language, based on information on the data type of the application; and a file generating unit that generates an interface-definition-language file in which information required for generating the broker program is expressed in the interface definition language using the data type of the interface definition language expressed by the data-type expressing unit.

A method according to another aspect of the present invention is for supporting development of a broker program configured to be installed in a middleware platform that realizes an interaction between plural applications described in various programming languages. The method includes data-type expressing including expressing, when a data type of a parameter for the application is out of a range of data type supported by an interface definition language, a predetermined data type of the interface definition language corresponding to the data type of the application in the interface definition language, based on information on the data type of the application; and file generating including generating an interface-definition-language file in which information required for generating the broker program is expressed in the interface definition language using the data type of the interface definition language expressed at the data-type expressing.

A computer-readable recording medium according to still another aspect of the present invention stores a computer program for supporting development of a broker program configured to be installed in a middleware platform that realizes an interaction between plural applications described in various programming languages. The computer program causes a computer to execute data-type expressing including expressing, when a data type of a parameter for the application is out of a range of data type supported by an interface definition language, a predetermined data type of the interface definition language corresponding to the data type of the application in the interface definition language, based on information on the data type of the application; and file generating including generating an interface-definition-language file in which information required for generating the broker program is expressed in the interface definition language using the data type of the interface definition language expressed at the data-type expressing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining a broker-program-development supporting apparatus according to a first embodiment of the present invention;

FIG. 2 is a block diagram of the broker-program-development supporting apparatus explained in FIG. 1;

FIG. 3 is a diagram for explaining a source-program/COBOL-registration-collection-file storing unit shown in FIG. 1;

FIG. 4 is a diagram for explaining an application-information-input-file storing unit shown in FIG. 1;

FIG. 5 is a diagram for explaining an IDL-file storing unit shown in FIG. 1;

FIG. 6 is a diagram for explaining a working-application-information-input-file storing unit shown in FIG. 1;

FIGS. 7 to 31 are diagrams for describing a COBOL-specific-process-source-file storing unit shown in FIG. 1;

FIGS. 32 to 34 are diagrams for describing a Bean-source-file storing unit shown in FIG. 1;

FIGS. 35 and 36 are diagrams for describing a Java™-source-file storing unit shown in FIG. 1;

FIG. 37 is a block diagram of an interface-analysis processing unit shown in FIG. 1;

FIG. 38 is a flowchart of a processing performed by the broker-program-development supporting apparatus shown in FIG. 1;

FIG. 39 is a flowchart of an interface analysis process mentioned in FIG. 38; and

FIG. 40 is a block diagram of a computer that executes a broker-program-development supporting program.

### DETAILED DESCRIPTION OF THE PREFERRED EMBODIMENTS

Exemplary embodiments of the present invention will be described in detail below with reference to the accompanying drawings. The present invention is not limited to the embodiments.

Terms used in the embodiments are described as follows. A server application is an application software that provides service functions, which is installed and operated in a computer connected to a network. The server application can be, but not limited to, a backbone operation application server for managing a personnel system or a finance system of a company, a data base server that stores a large amount of data for providing information in response to various requests, or a WWW server that is connected to the Internet or an intranet for providing various information. The server applications are programs described in various programming languages, such as COBOL and Java™, registered trademark (hereinafter, “Java™”)

A client application is an application software that uses a service function provided by the server application, which is installed and operated in a computer connected to a network. The client application can be, but not limited to, an application software that operates a personnel system or a finance system provided by the backbone operation application server, an application software that sends a request to the data base server to search information stored in the data base server, or an application software that accesses the WWW server to acquire various information. The client applications are programs described in various programming languages.

The COBOL is a programming language established for use in office processing and calculation. Java™ is an object-oriented programming language.

A middleware platform is a platform software that realizes interaction between plural applications described in various programming languages. The middleware platform realizes interaction between, for example, server applications described in COBOL or Java™ and client applications described in Java™, or between plural server applications described in COBOL or Java™.

A broker program is required for brokering an interaction between server applications and client applications installed in the middleware platform. A COBOL-specific-process source file is a broker program for brokering an interaction between an application described in COBOL and an application described in a programming language other than COBOL. A Bean source file and a Java™ source file are broker programs for brokering an interaction between an application described in Java™ and an application described in a programming language other than Java™.

A data type is a type of data that can be stored in a parameter for an application. The data type can be, for example, an integer number type or a text type.

An IDL is a language for describing interface definition information for an application, for example, a data type definition of a parameter for an application.

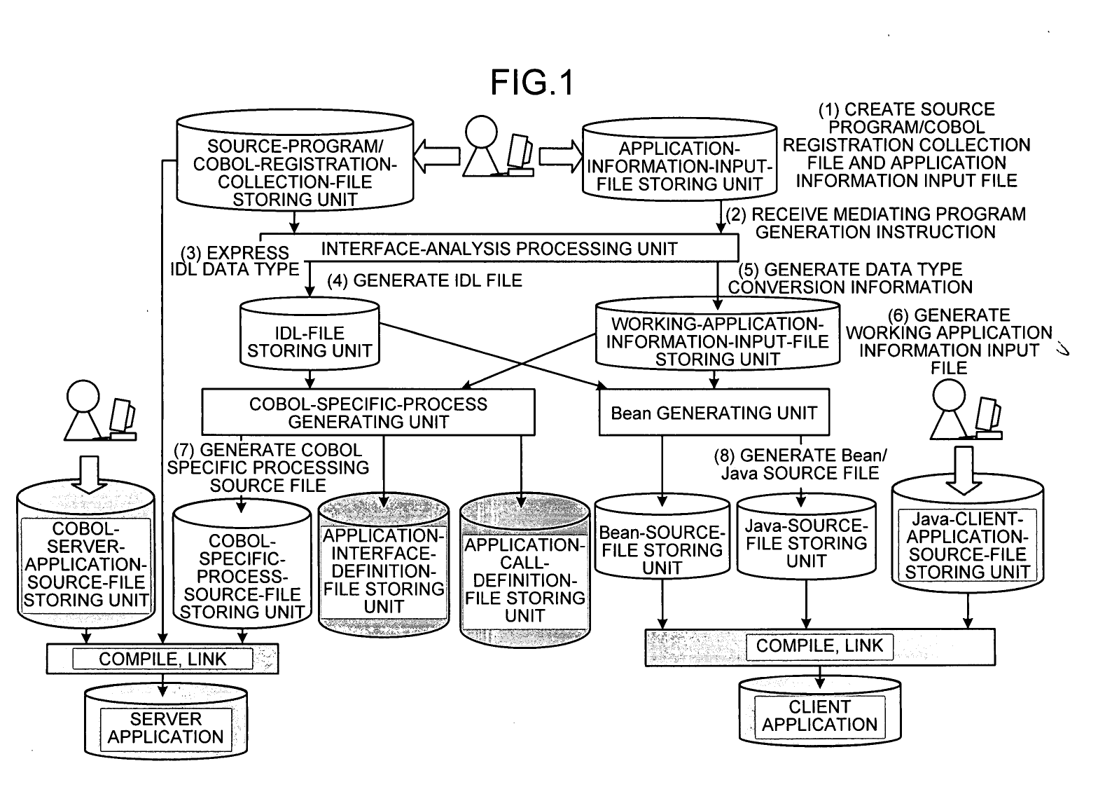

FIG. 1 is a diagram for explaining a broker-program-development supporting apparatus according to a first embodiment of the present invention. In the following description, it is assumed that the broker-program-development supporting apparatus supports development of a broker program for brokering an interaction between a server application described in COBOL and a client application described in Java™.

The broker-program-development supporting apparatus is installed in a middleware platform that realizes interaction between plural applications described in various programming languages. The broker-program-development supporting apparatus is capable of reducing the amount of work required of a developer for creating a broker program, when a data type of a parameter for an application is not included among those supported by IDL.

In the broker-program-development supporting apparatus, a source program/COBOL registration collection file is stored in a source-program/COBOL-registration-collection-file storing unit (see (1) of FIG. 1). The source program/COBOL registration collection file includes a data type definition of a parameter for a server application. The data type definition is described in COBOL by a developer of the server application. In the broker-program-development supporting apparatus, an application information input file is stored in an application-information-input-file storing unit (see (1) of FIG. 1). The application information input file includes information, which is described by the developer, required for developing a broker program. The information is, for example, information on the server application and a method of analyzing the COBOL registration collection.

The broker-program-development supporting apparatus receives a broker-program generation instruction for operating the broker-program-development supporting apparatus (see (2) of FIG. 1). The broker-program-development supporting apparatus expresses in IDL an IDL data type corresponding to a data type of the server application based on information on the data type of the server application (see (3) of FIG. 1). Specifically, if the data type of the application is included among those supported by IDL, the corresponding IDL data type is expressed in IDL. On the other hand, if the data type of the application is not included among those supported by IDL, a predetermined IDL data type made to correspond to the data type of the application is expressed in IDL.

For example, when the data type of the parameter for the application is PIC N(10), the data type is included among those supported by IDL. Therefore, the corresponding IDL data type, wstring, is expressed in IDL. On the other hand, when the data type of the application is PIC 9(6) COMP-3, the data type is not included among those supported by IDL. Therefore, an IDL data type, string, which is made to correspond to PIC 9(6) COMP-3, is expressed in IDL.

The broker-program-development supporting apparatus generates an IDL file from the IDL data type expressed in IDL (see (4) of FIG. 1). The IDL file is information expressed in IDL, which is required for generating a broker program. Specifically, the IDL file is generated from information such as the IDL data type, an operation name described in the application information input file, a return value type, and a parameter name.

The broker-program-development supporting apparatus generates data type conversion information required for converting the data type of the server application into a data type of COBOL or a data type of Java™ (see (5) of FIG. 1). For example, when the data type of the server application is PIC 9(6) COMP-3, the data type conversion information includes the fact that a corresponding data type definition of COBOL is PIC 9(6) COMP-3, and a function name for data conversion.

The broker-program-development supporting apparatus generates a working application information input file from the generated data type conversion information and the information described in the application information input file (see (6) of FIG. 1).

The broker-program-development supporting apparatus generates a COBOL-specific-process source file, which is a broker program, from the generated IDL file and the generated working application information input file (see (7) of FIG. 1). The broker-program-development supporting apparatus generates a Bean source file and a Java™ source file, which are broker programs (see (8) of FIG. 1).

The COBOL-specific-process source file generated by the broker-program-development supporting apparatus is compiled and linked with a COBOL server application source file created by a developer. Accordingly, a server application is installed in a middleware platform. Similarly, the Bean source file and the Java™ source file generated by the broker-program-development supporting apparatus are compiled and liked with a Java™ client application source file created by a developer. Accordingly, a client application is installed in the middleware platform.

Accordingly, with the broker-program-development supporting apparatus according to the first embodiment, there is a lower chance that the developer will make a definition error, than with the conventional method in which the developer needs to prepare a special correspondence table by defining an IDL data type according to newly set description rules. Moreover, the developer does not need to manage special correspondence tables prepared for different applications. Thus, the amount of work required of the developer for creating a broker program is reduced, when a data type of a parameter for an application is not included among those supported by IDL.

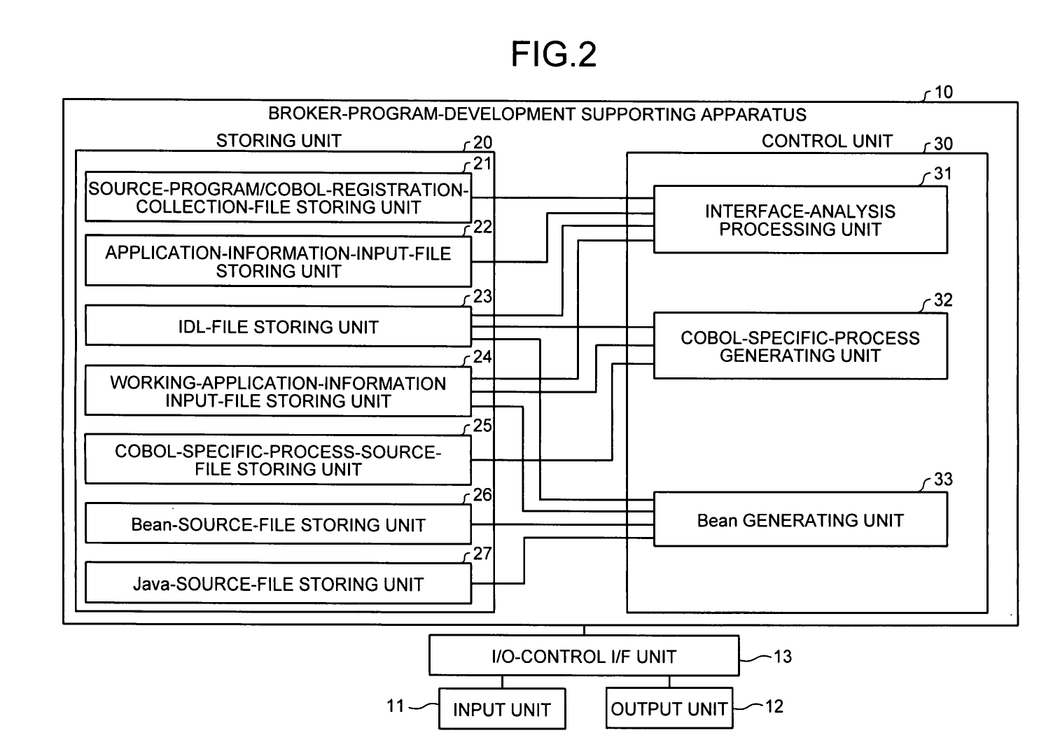

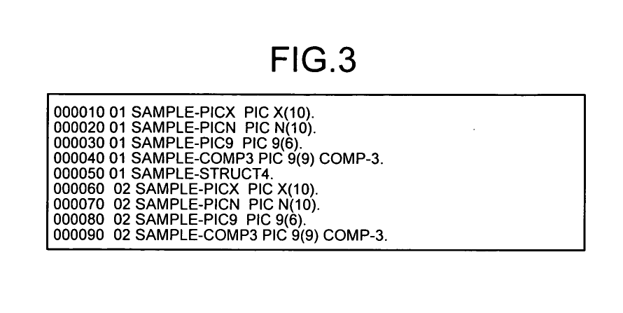

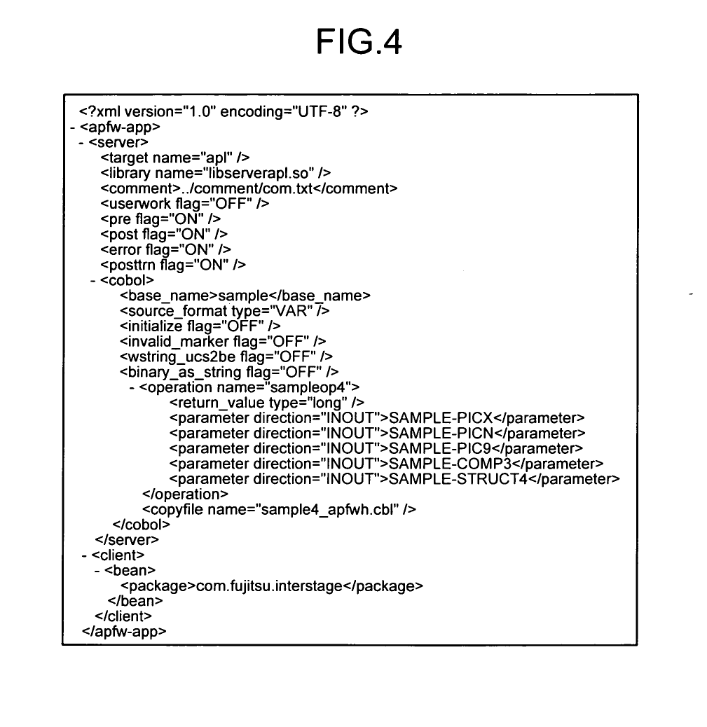

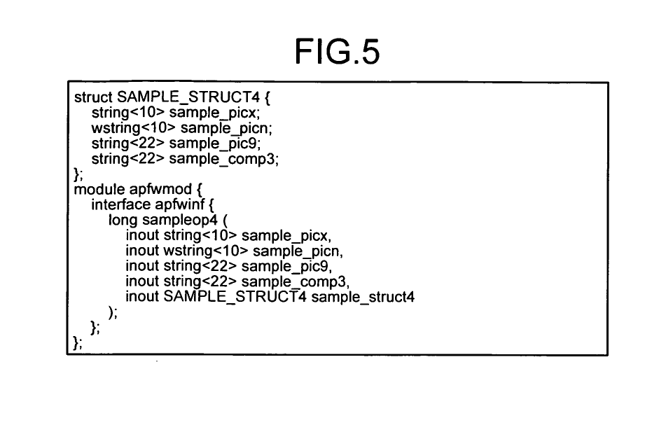

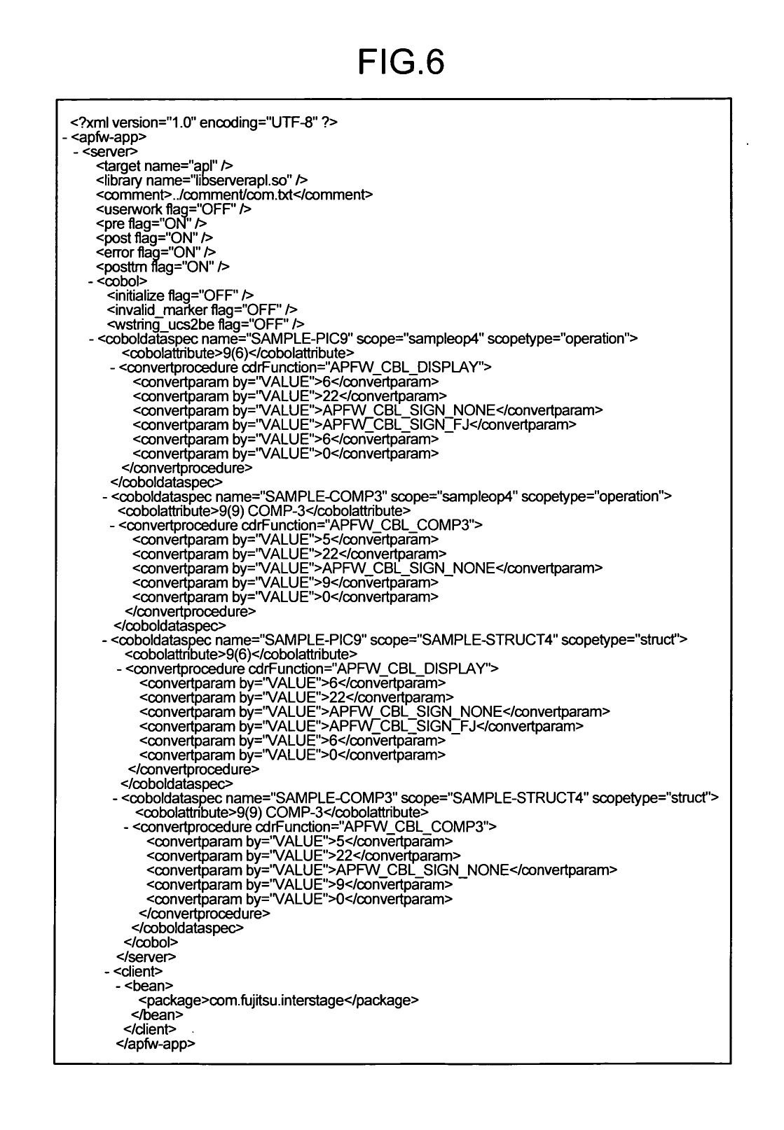

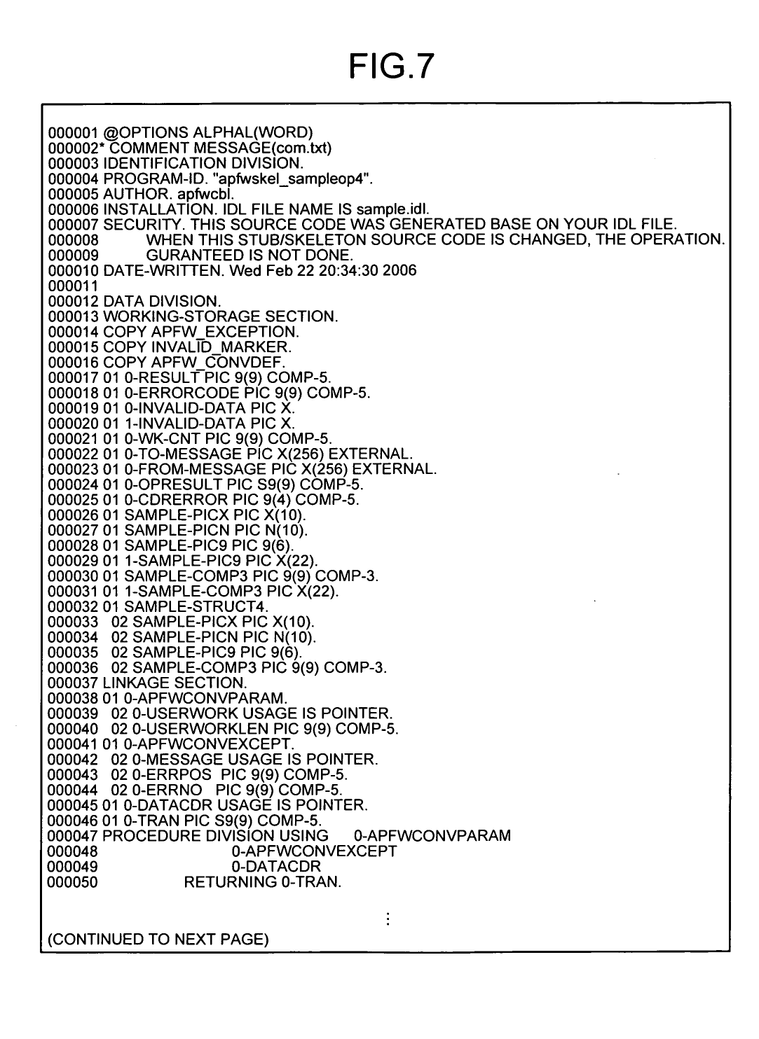

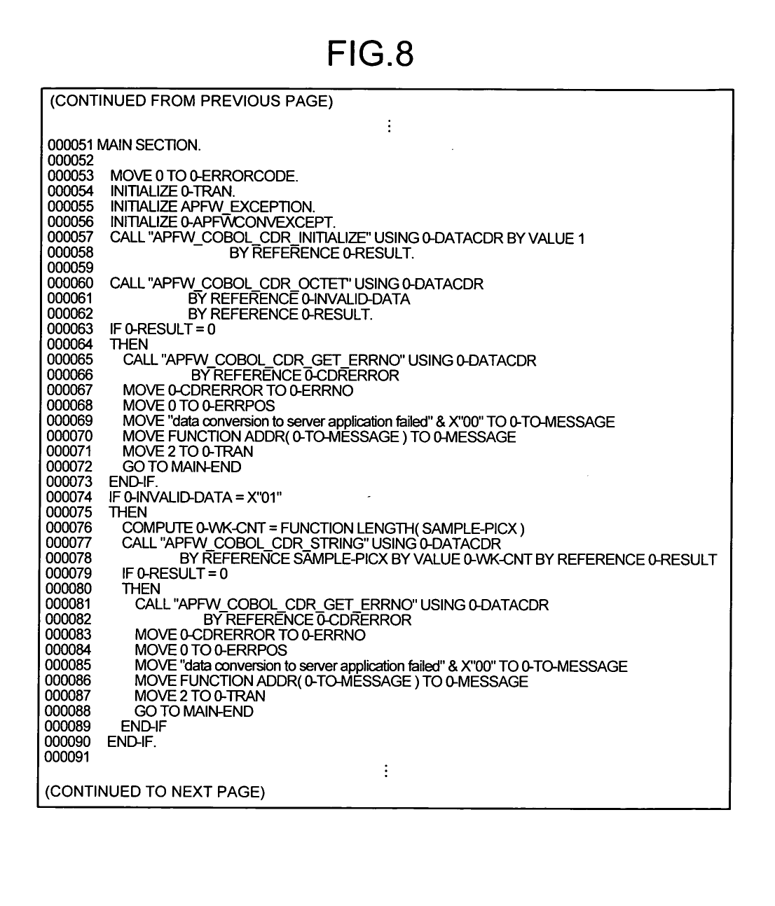

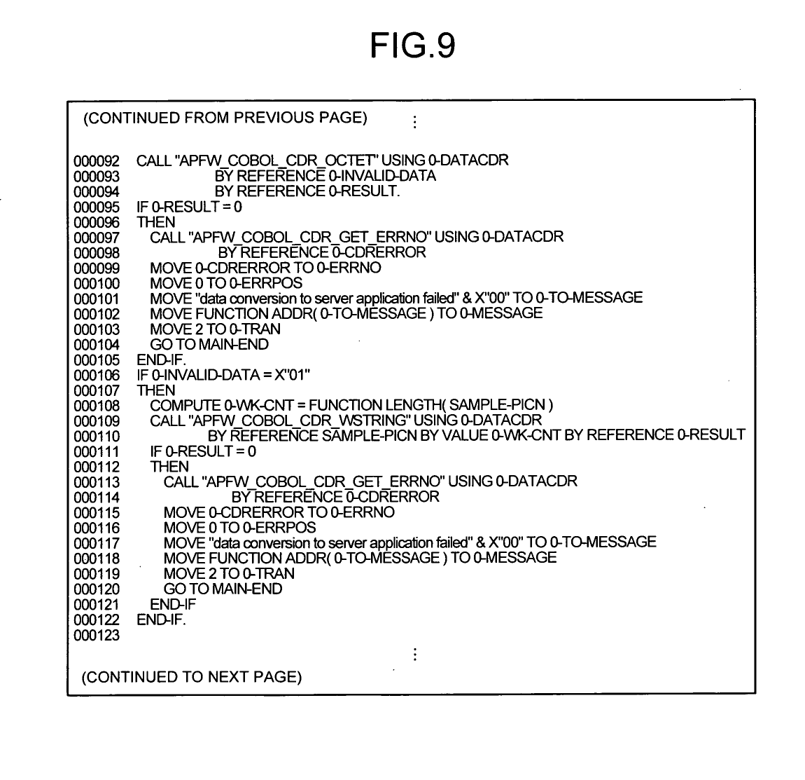

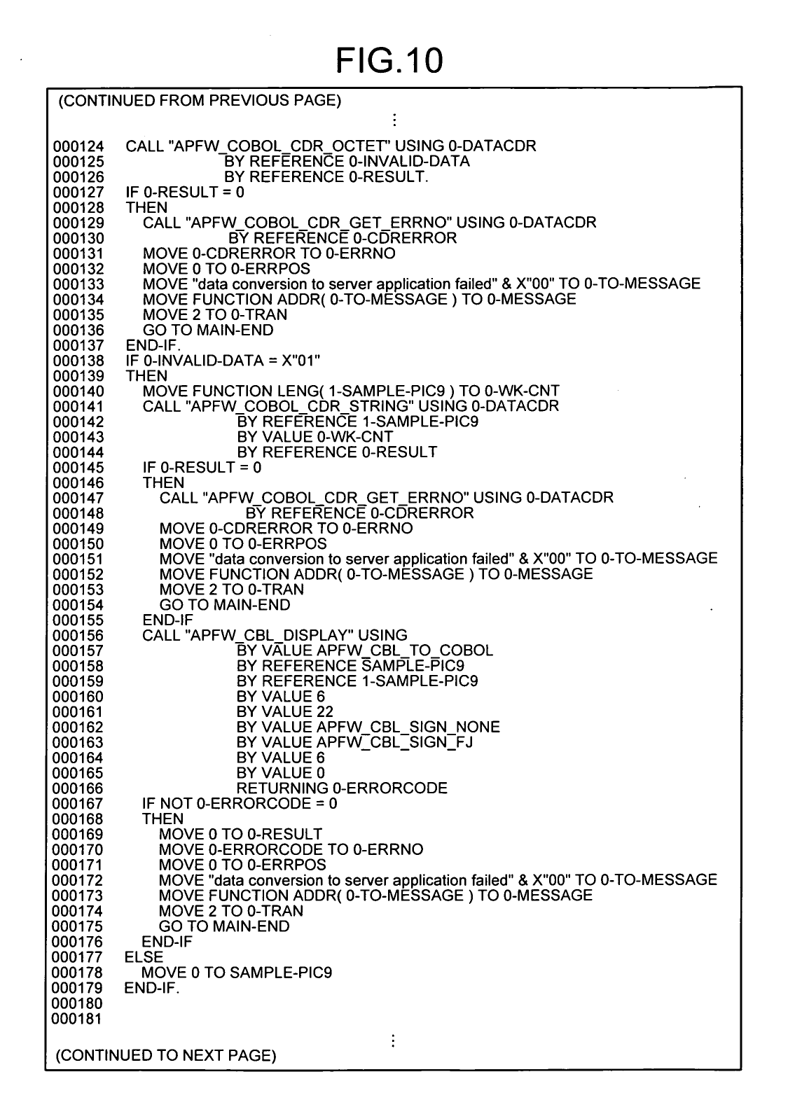

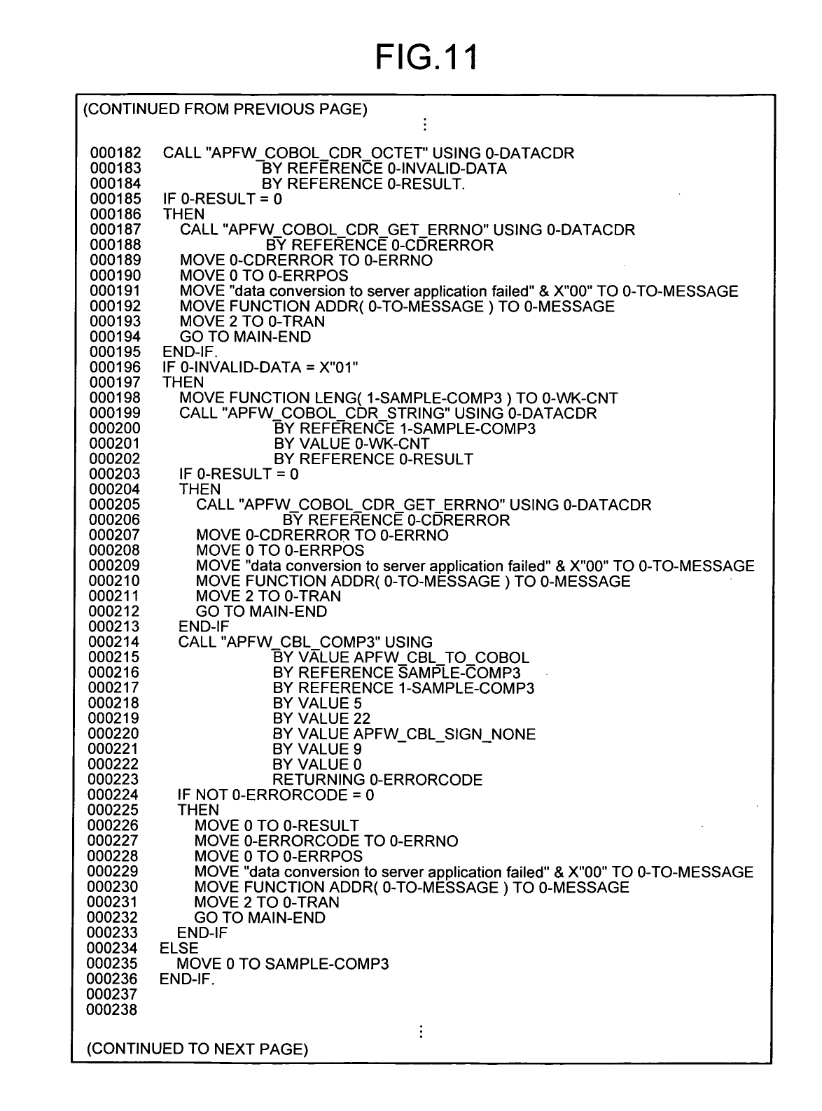

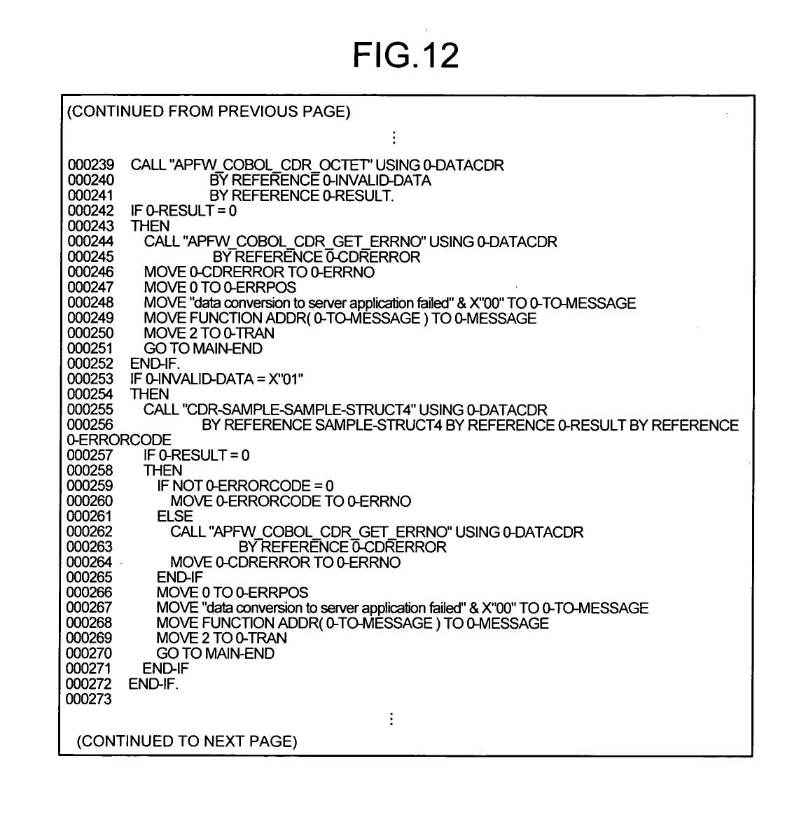

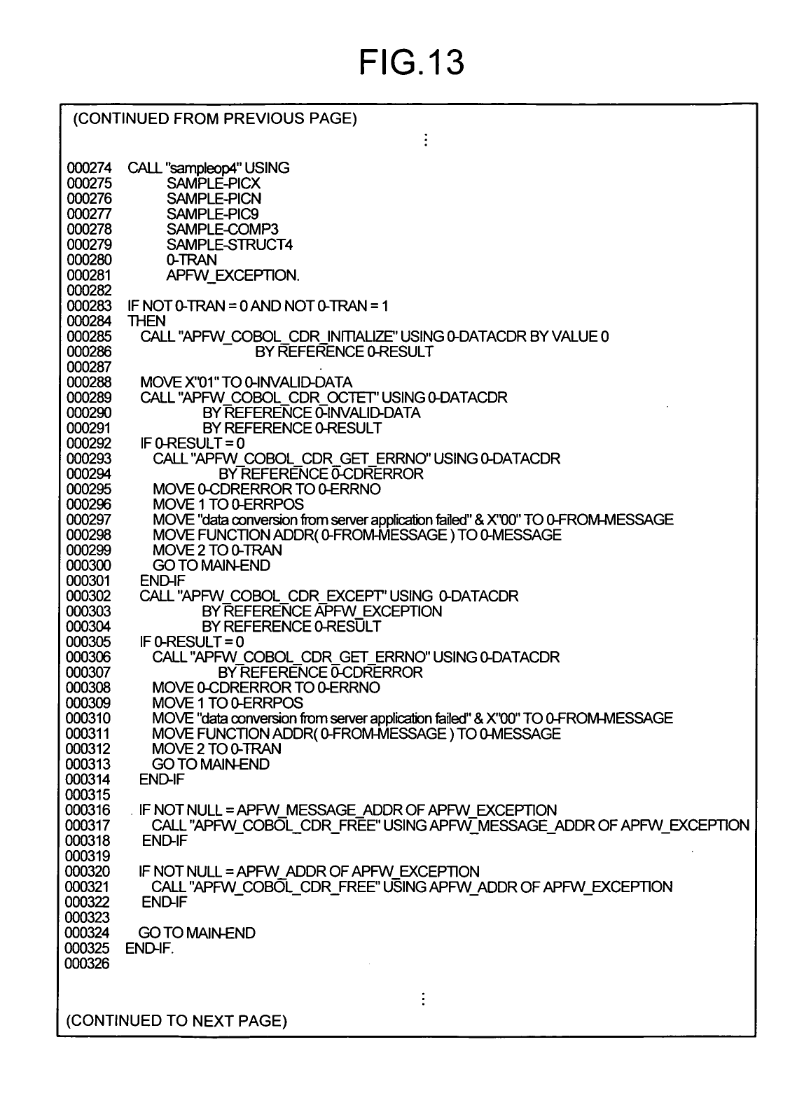

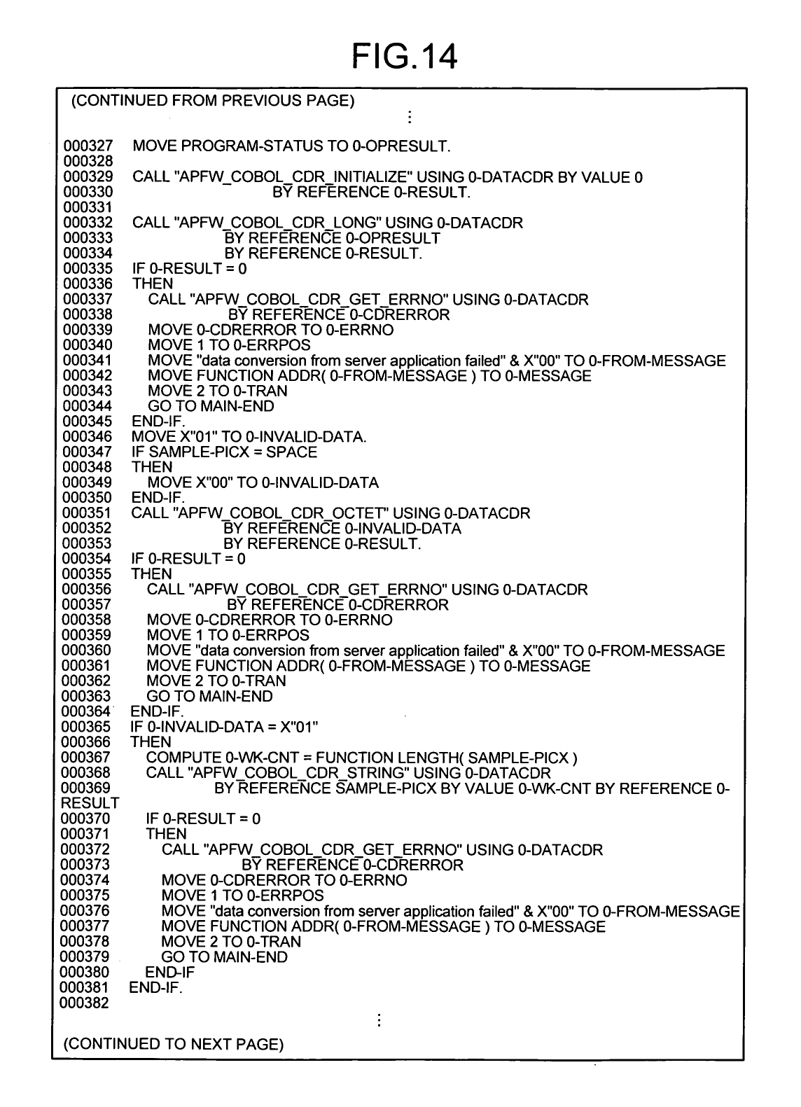

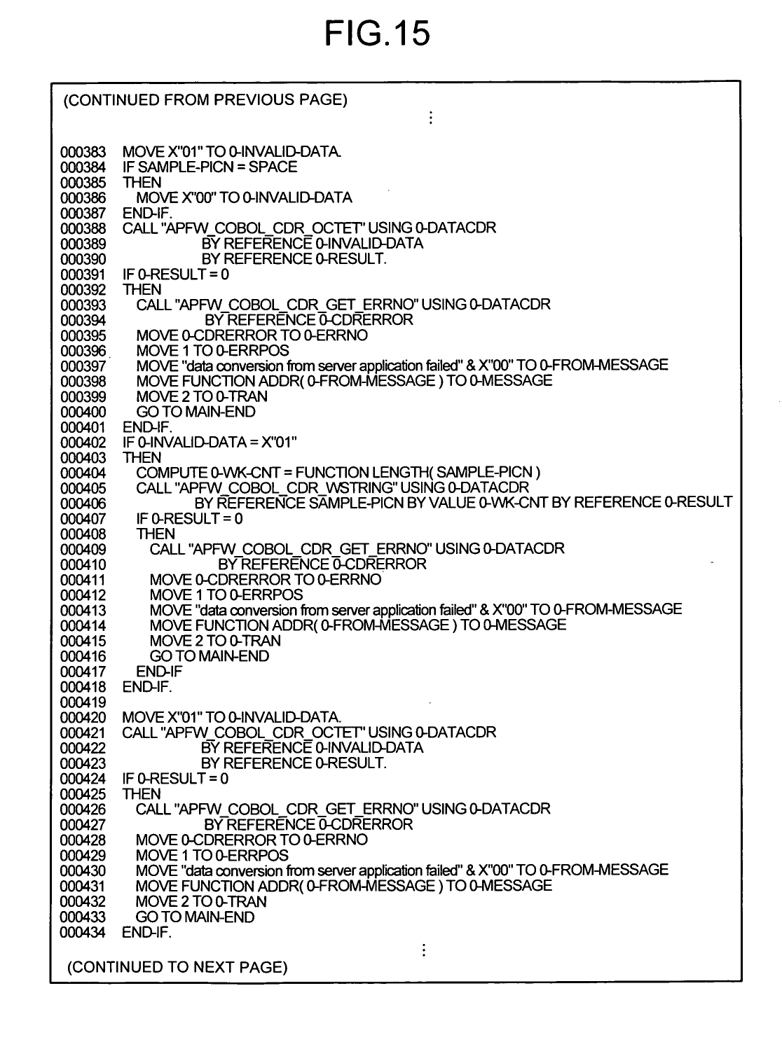

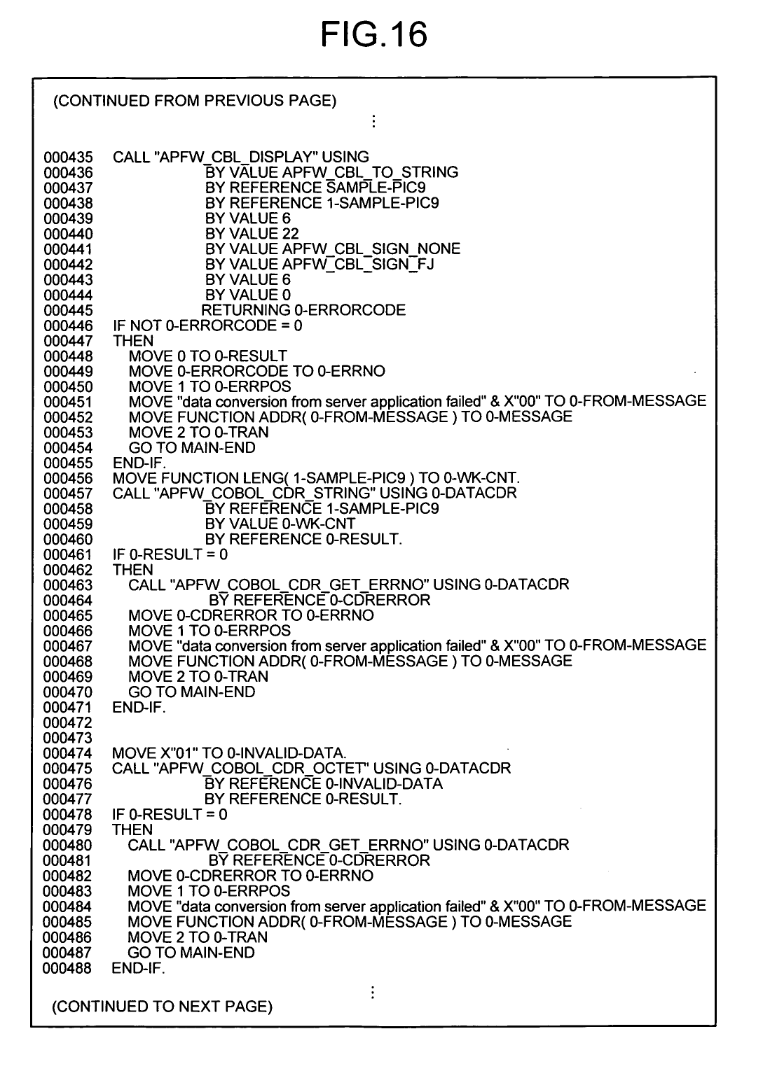

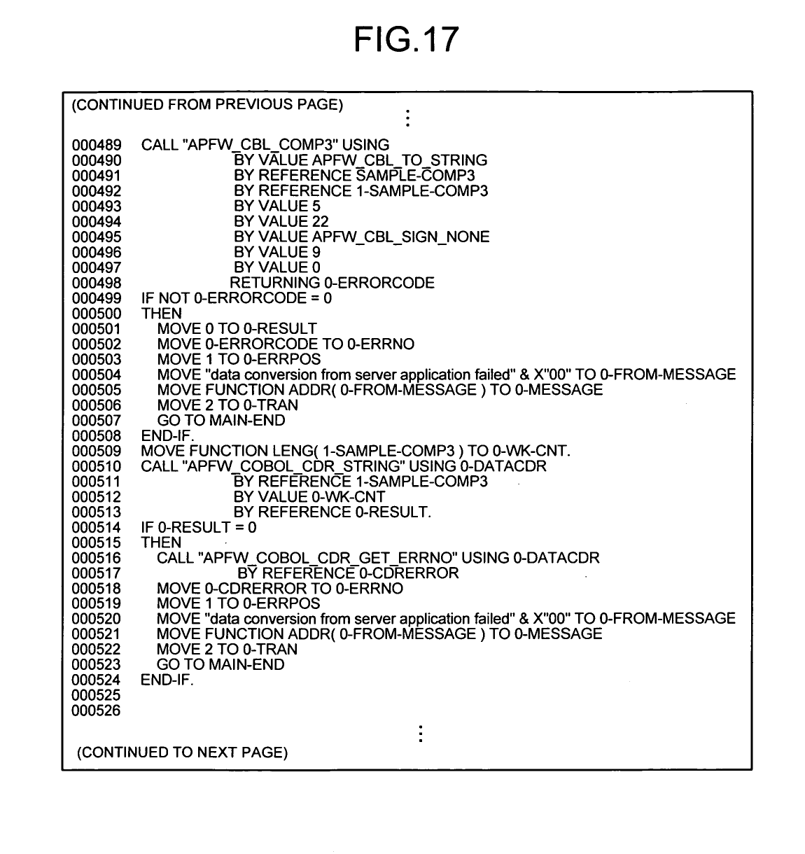

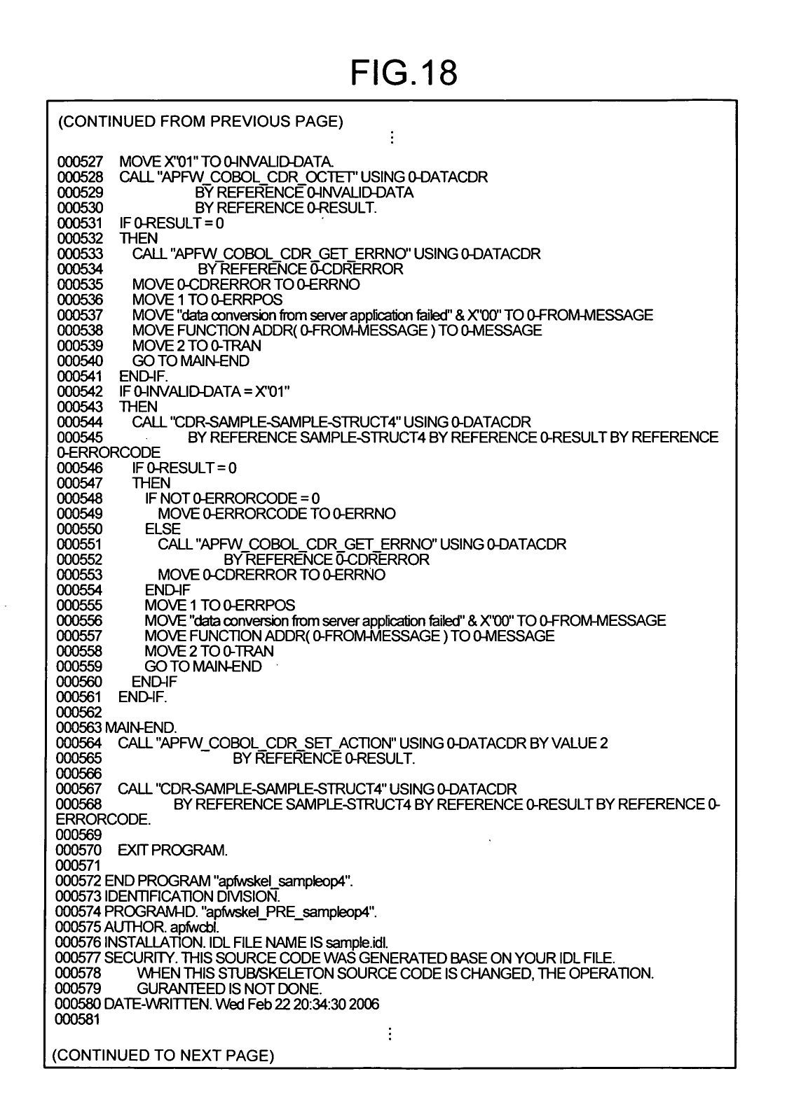

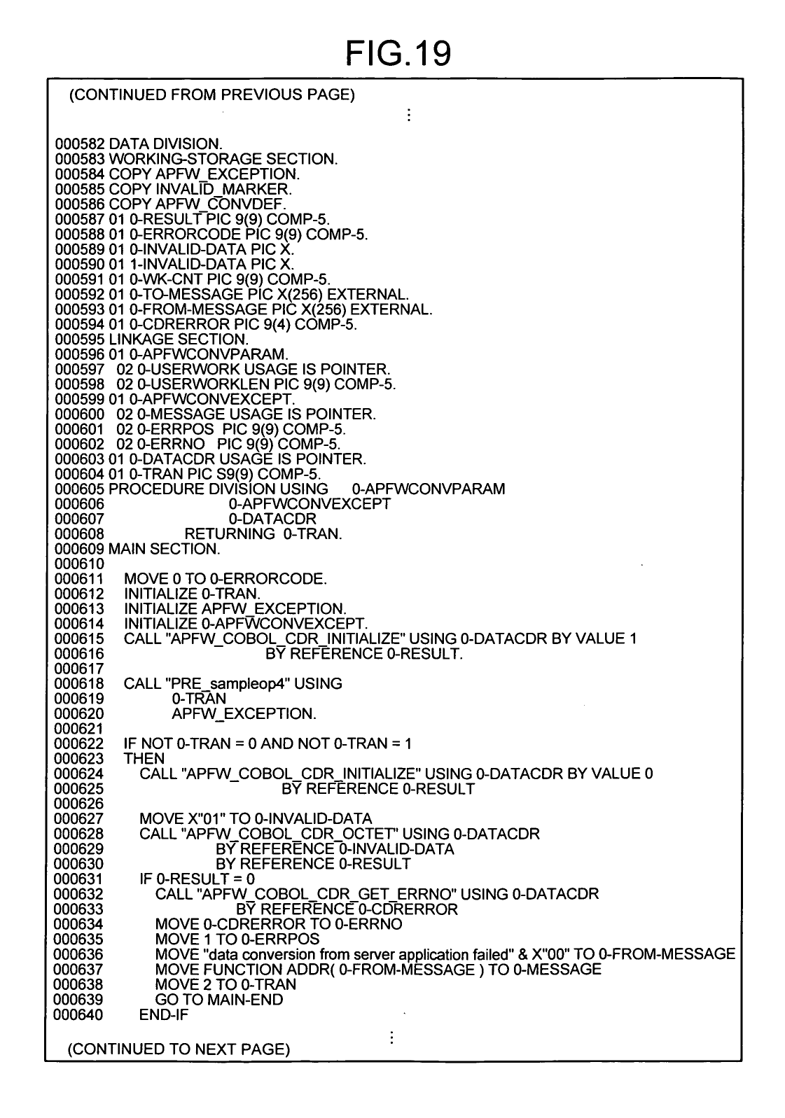

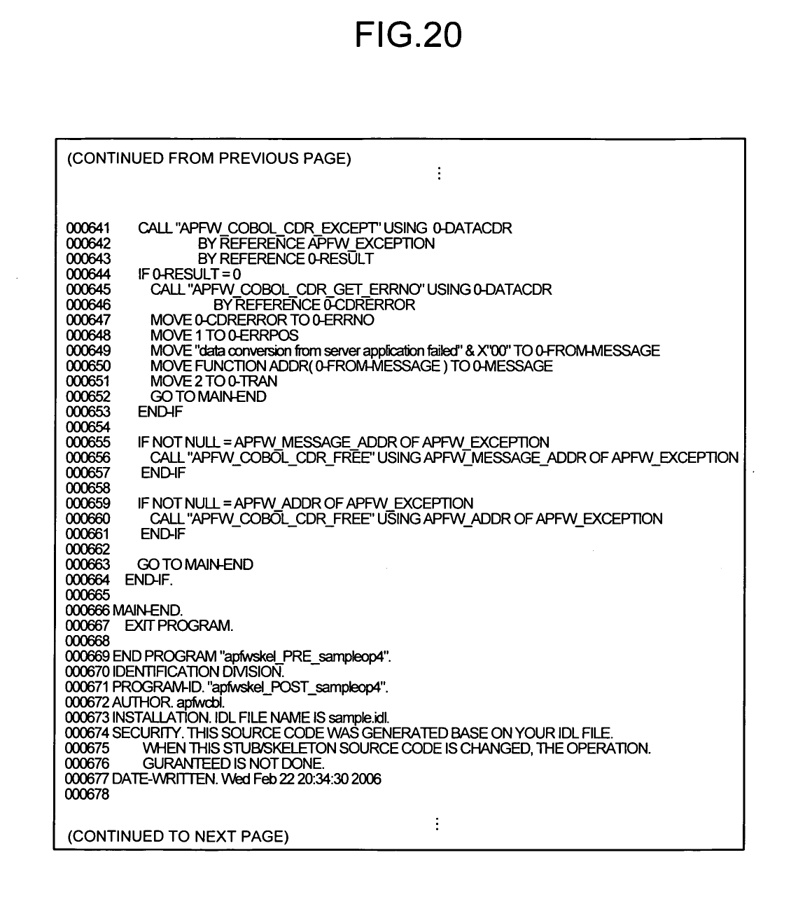

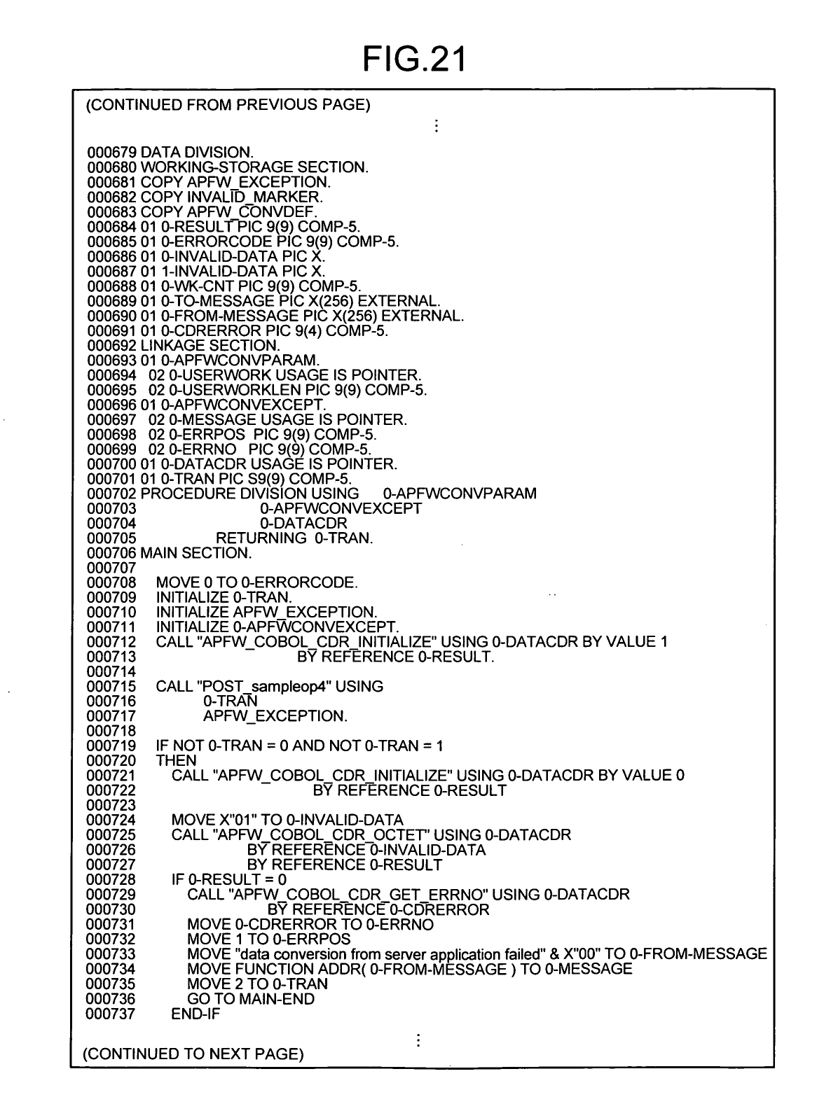

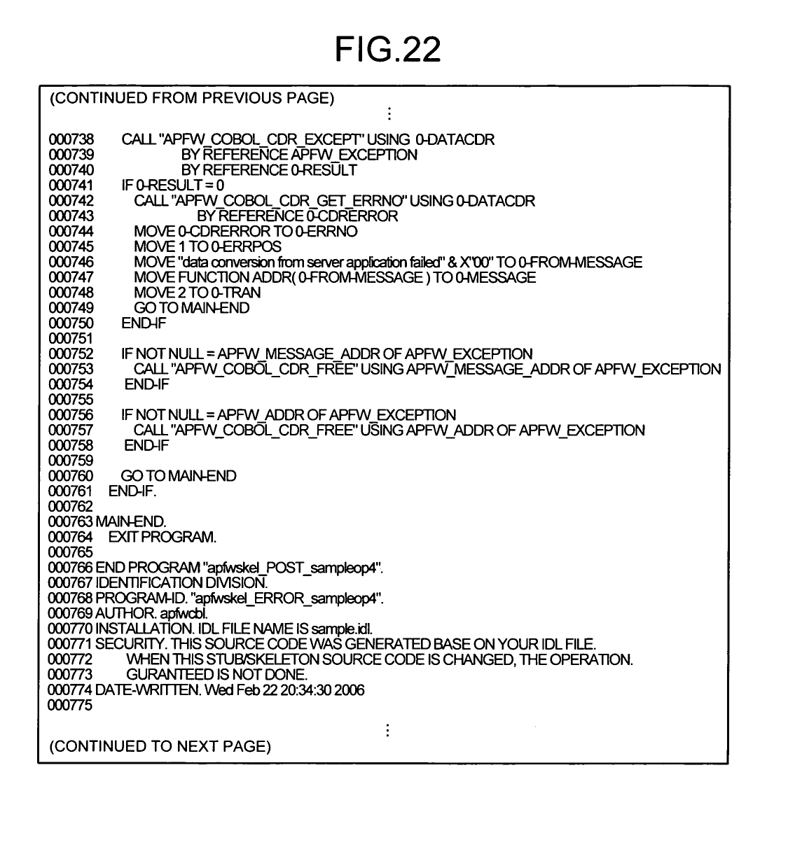

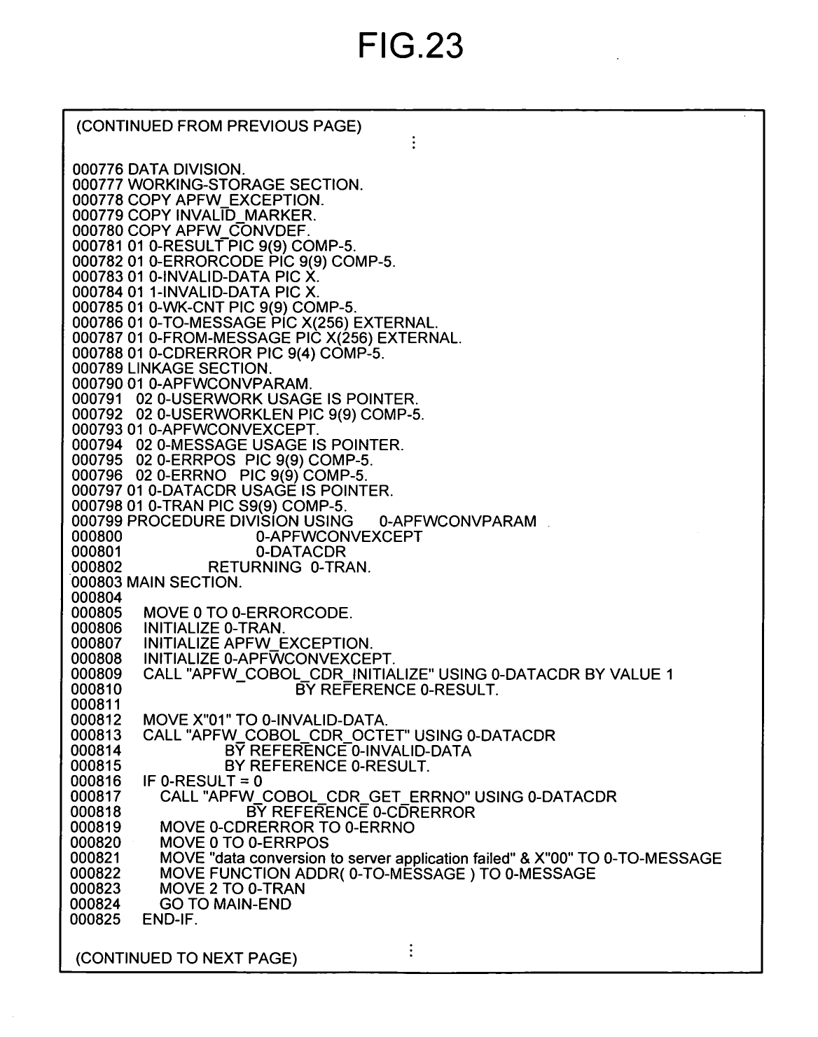

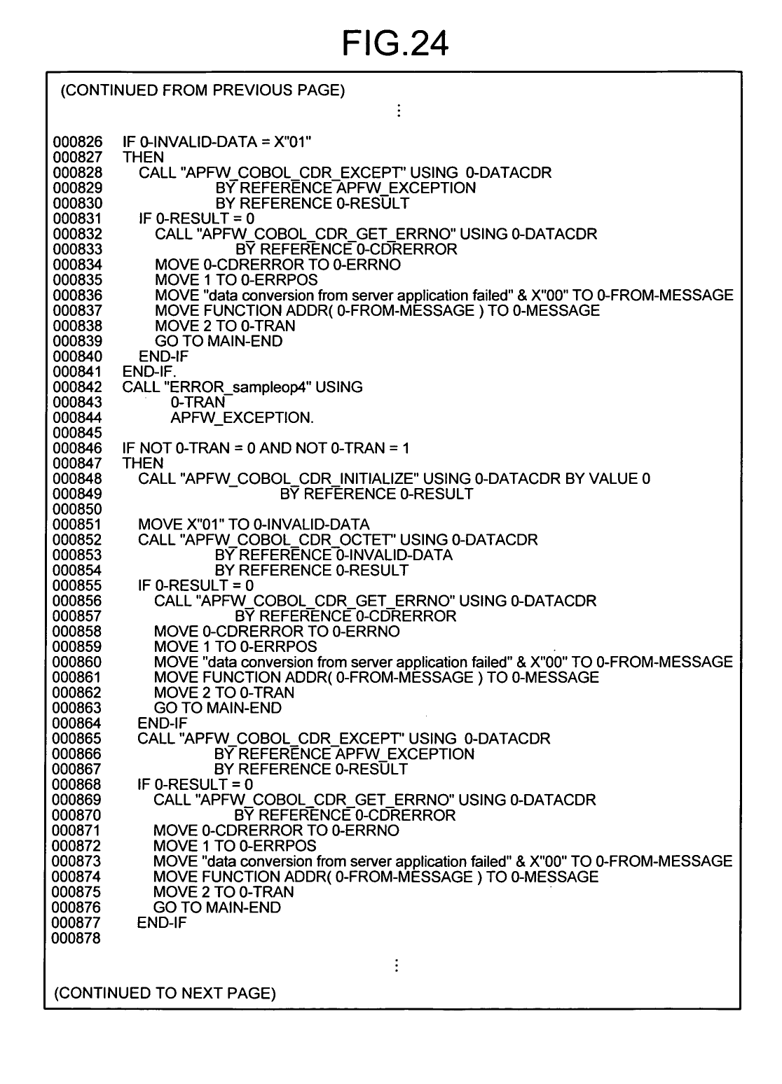

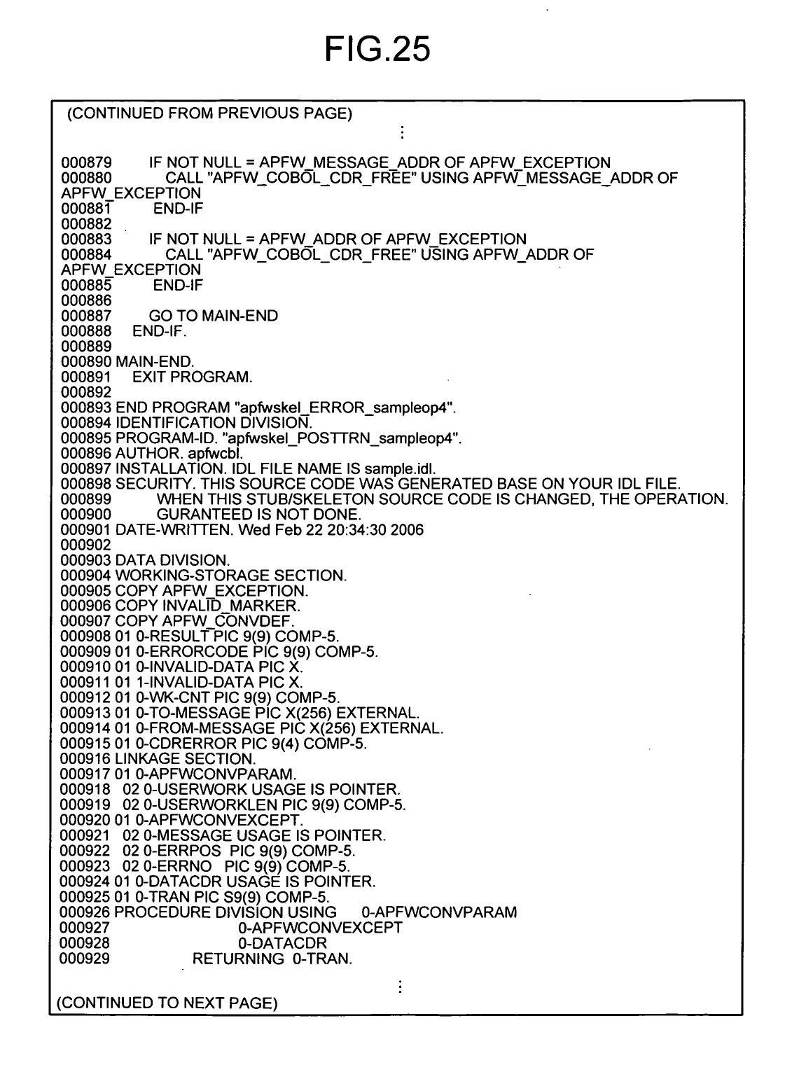

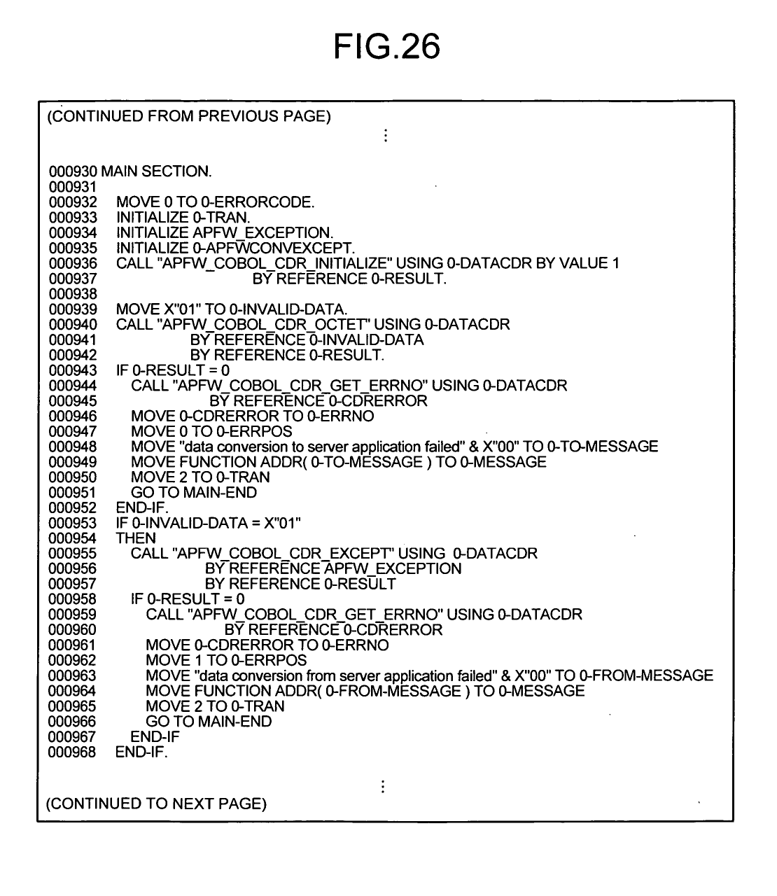

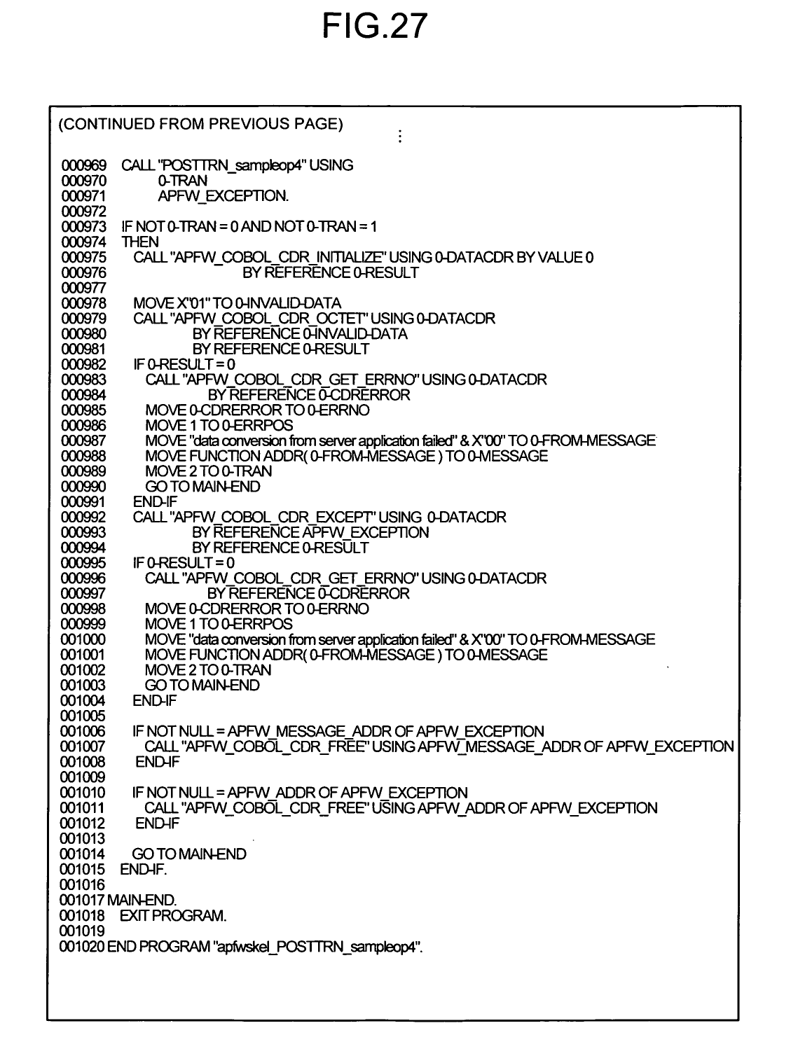

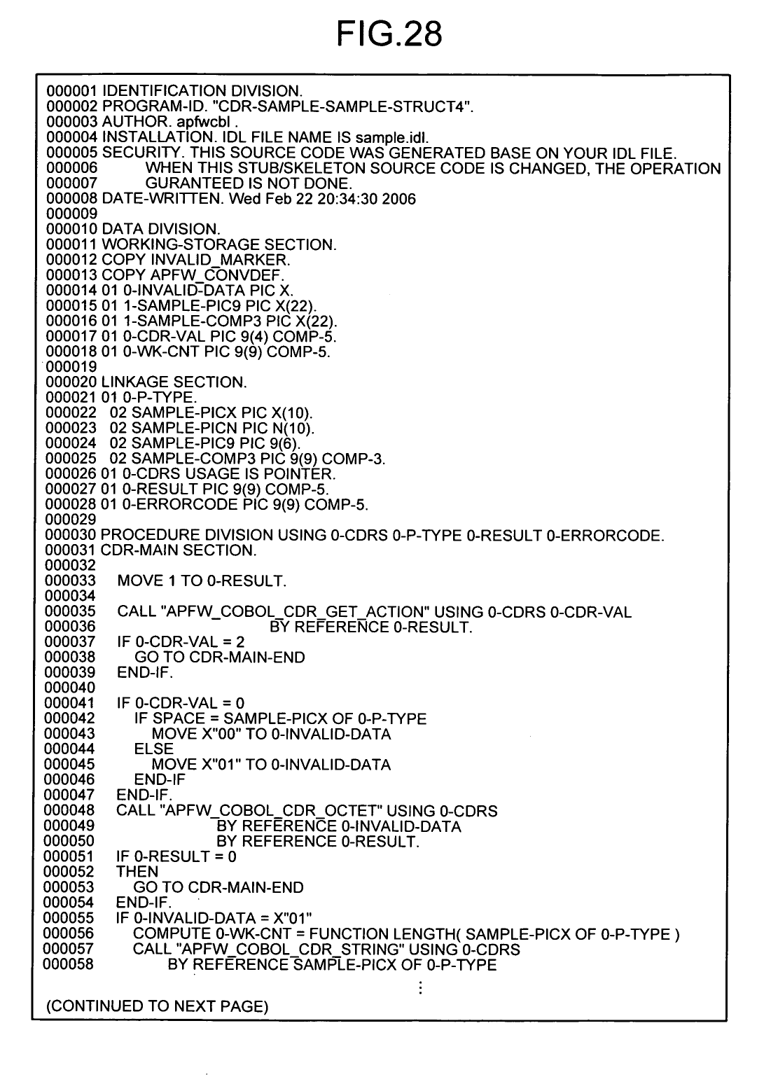

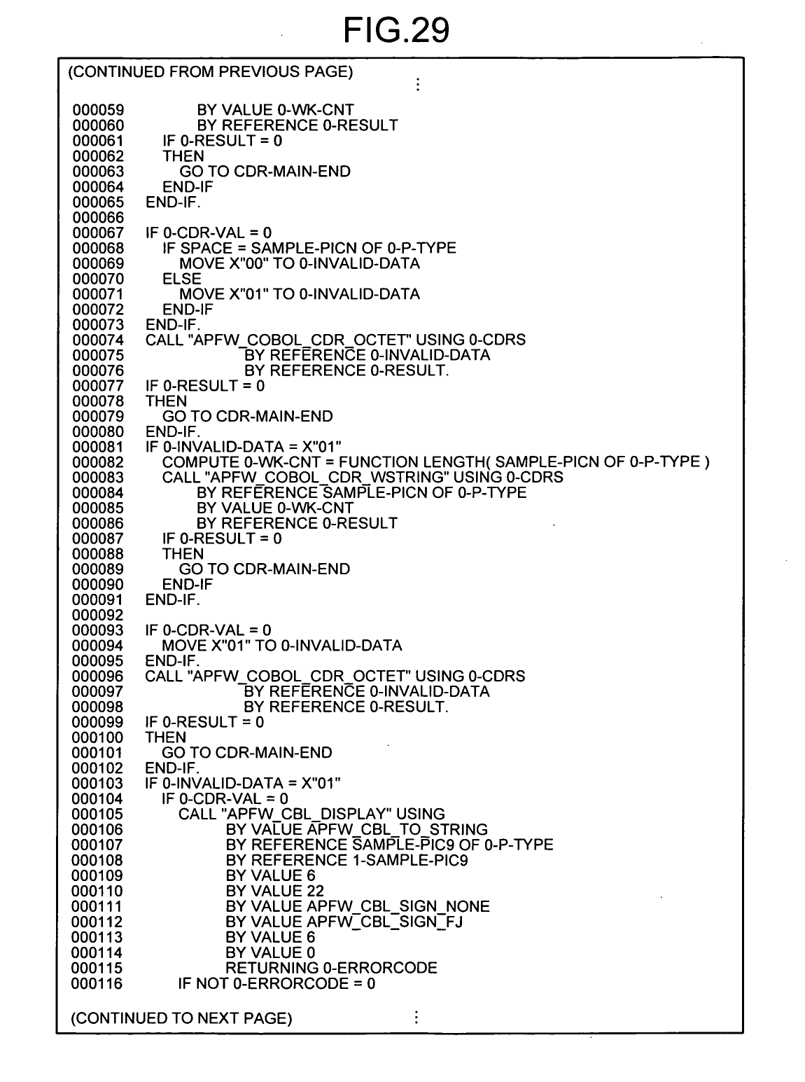

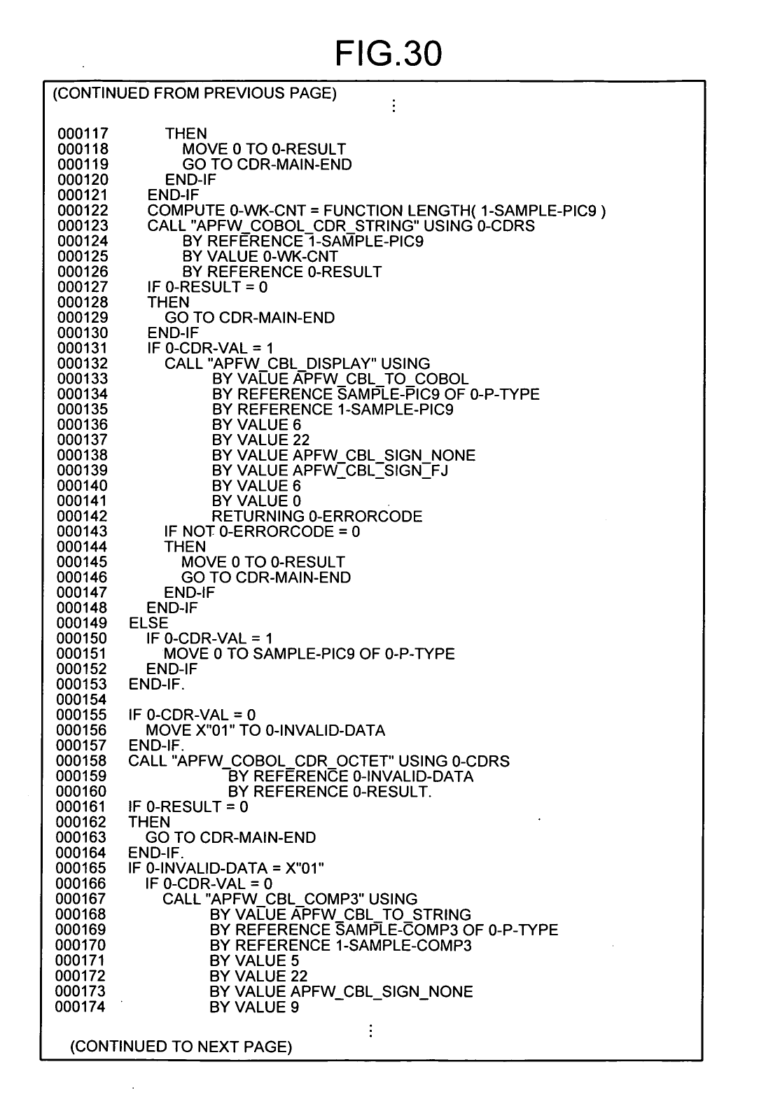

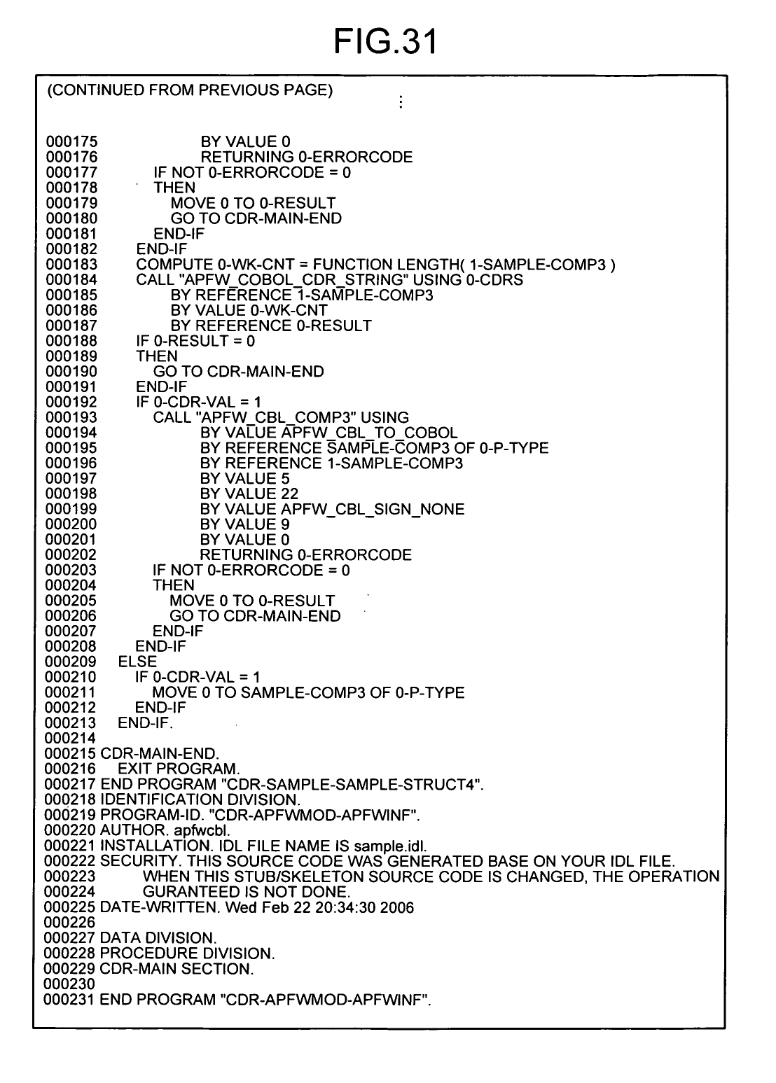

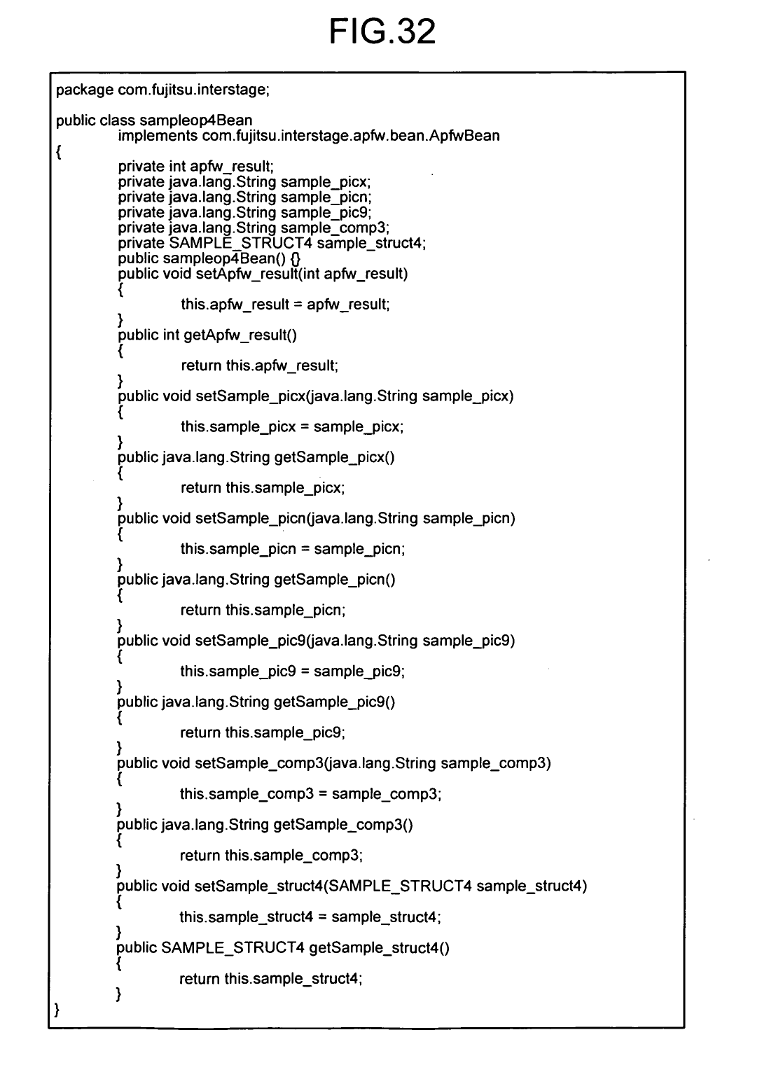

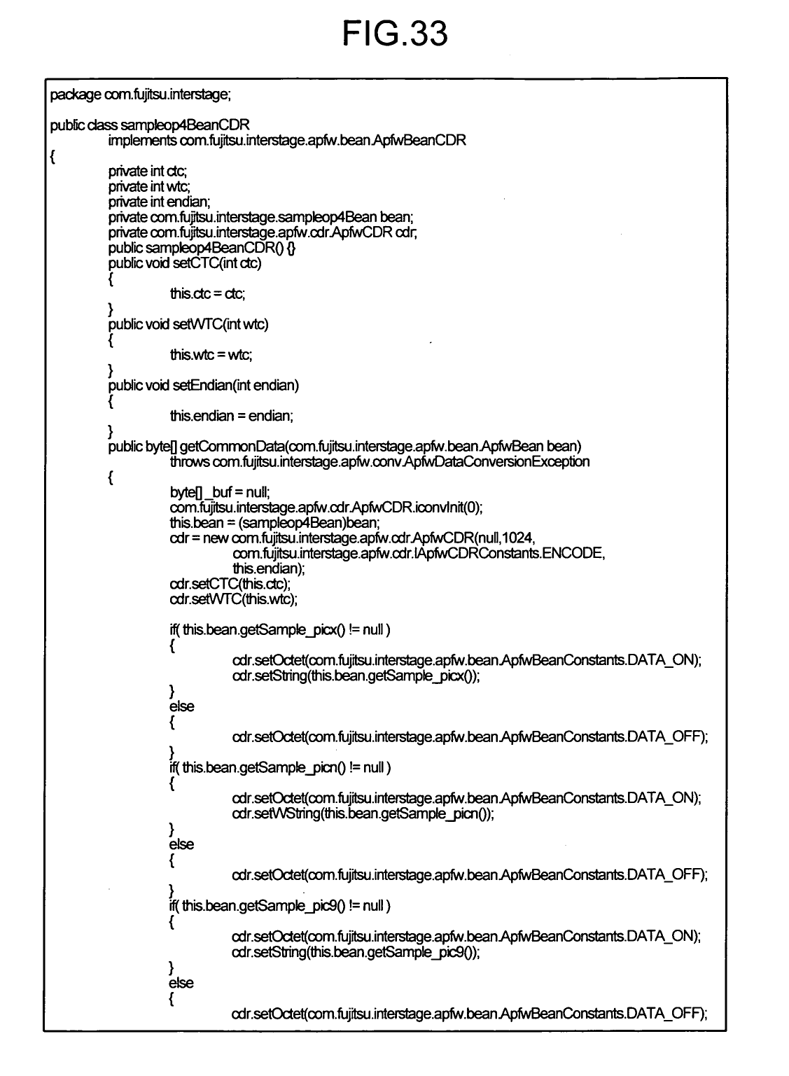

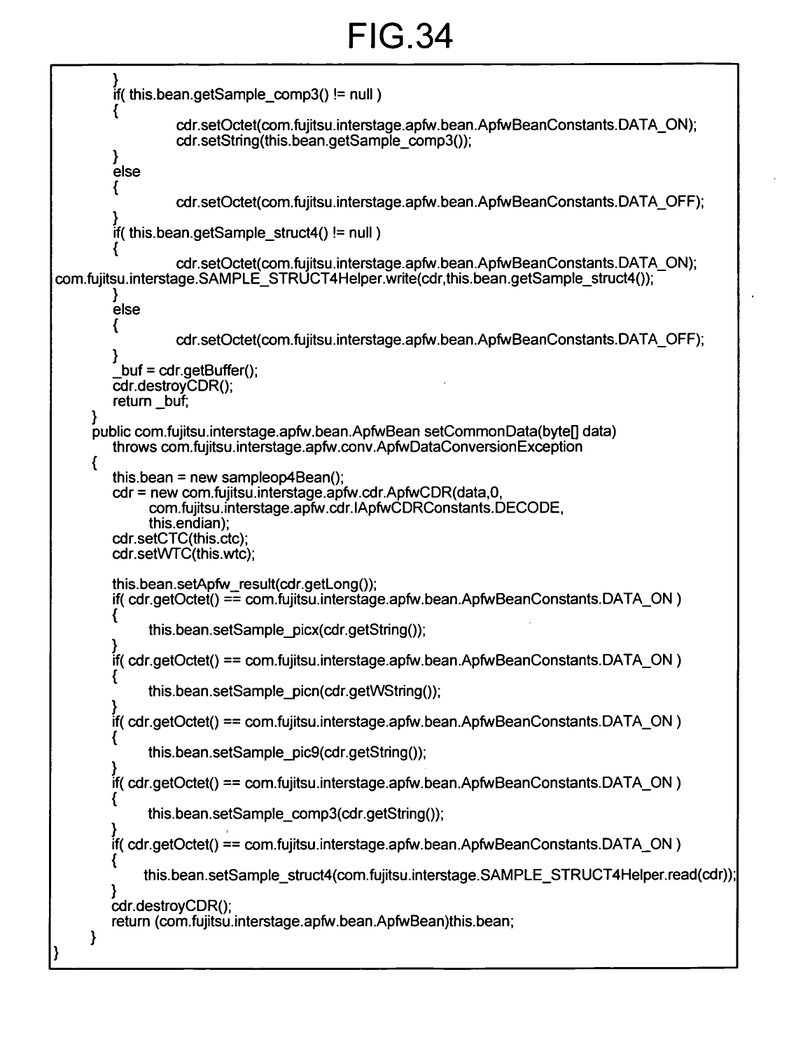

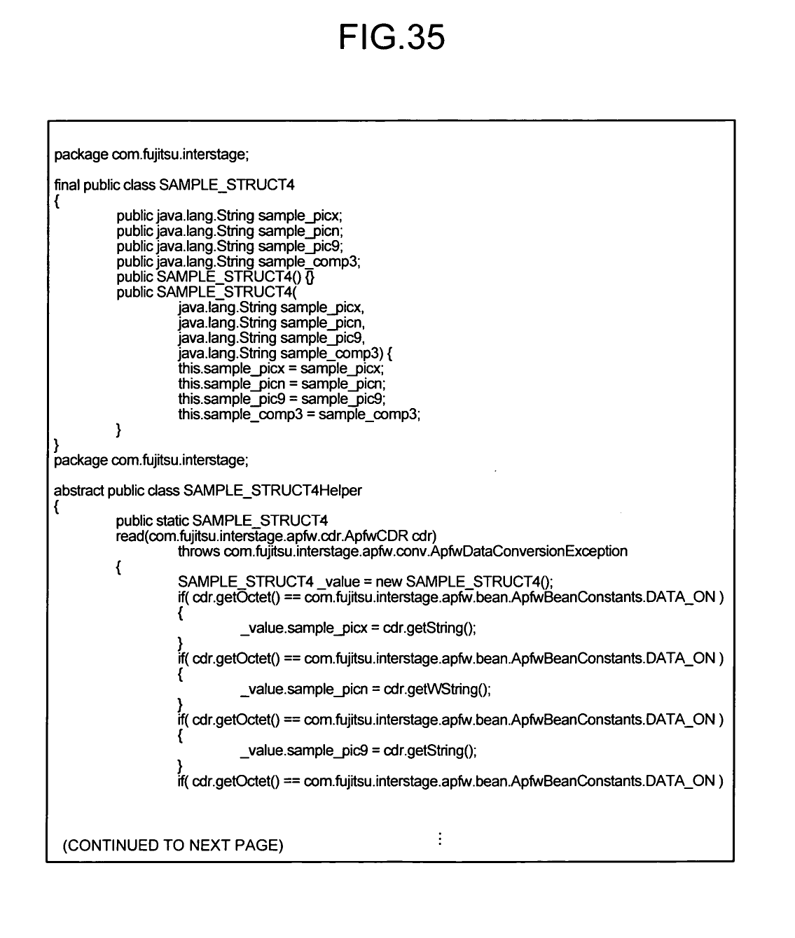

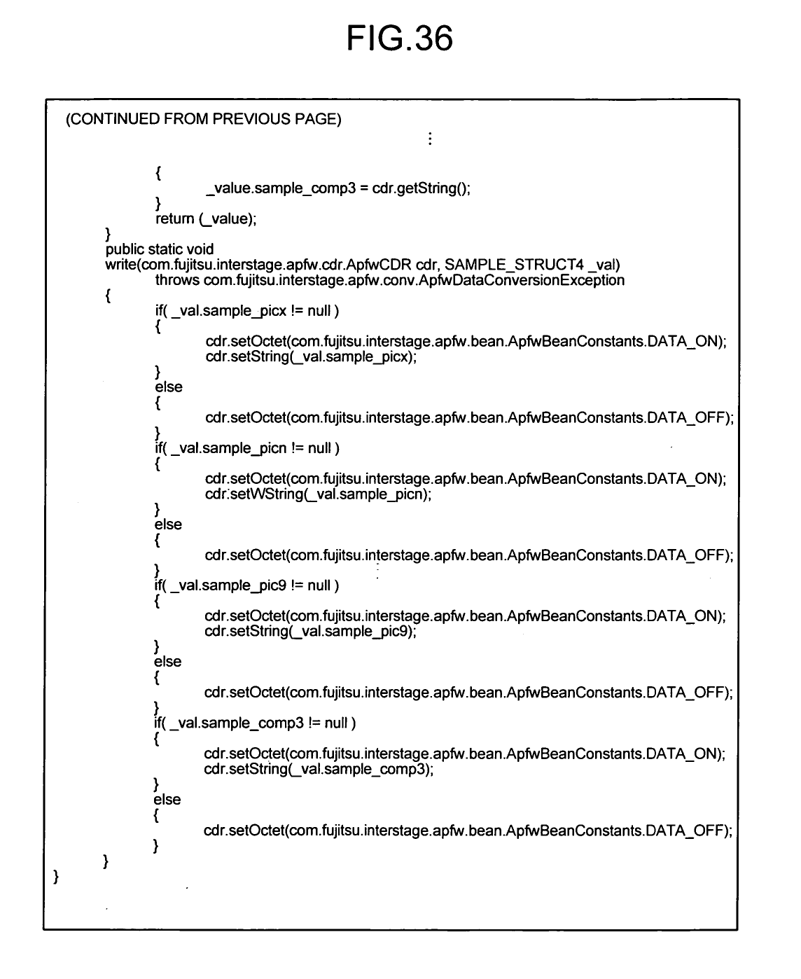

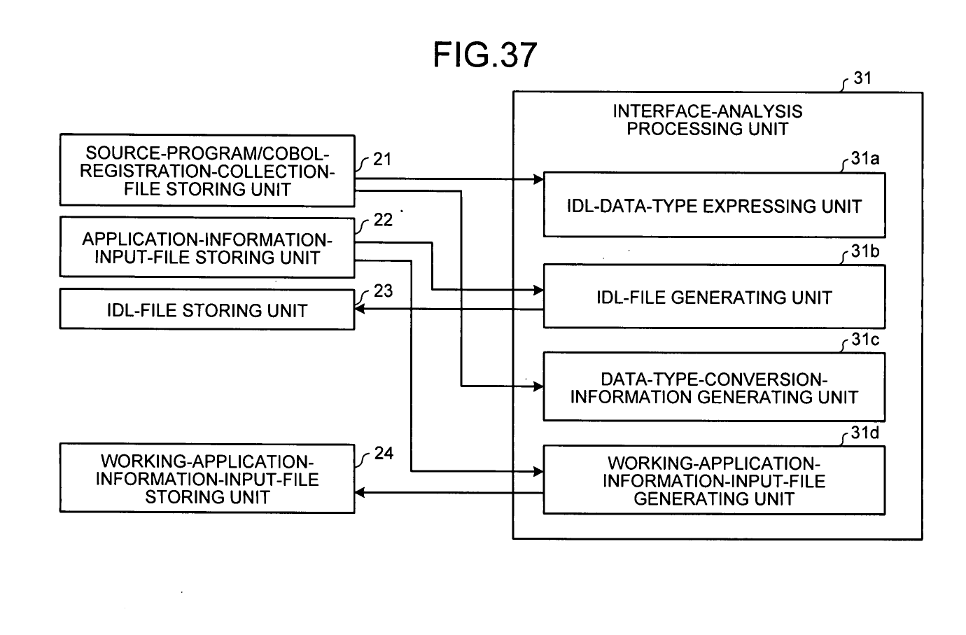

A broker-program-development supporting apparatus 10 according to the first embodiment is described with reference to FIGS. 2 to 37. FIG. 2 is a block diagram of the broker-program-development supporting apparatus 10 according to the first embodiment. FIG. 3 is a diagram for explaining a source-program/COBOL-registration-collection-file storing unit 21. FIG. 4 is a diagram for explaining an application-information-input-file storing unit 22. FIG. 5 is a diagram for explaining an IDL-file storing unit 23. FIG. 6 is a diagram for explaining a working-application-information-input-file storing unit 24. FIGS. 7 to 31 are diagrams for describing a COBOL-specific-process-source-file storing unit 25. FIGS. 32 to 34 are diagrams for describing a Bean-source-file storing unit 26. FIGS. 35 and 36 are diagrams for describing a Java™-source-file storing unit 27. FIG. 37 is a block diagram of an interface-analysis processing unit 31.

As shown in FIG. 2, the broker-program-development supporting apparatus 10 includes an input unit 11, an output unit 12, an input/output (I/O)-control interface (I/F) unit 13, a storing unit 20, and a control unit 30.

The input unit 11 receives information such as data used for processings performed by the control unit 30 and operation instructions for the processings. The information can be input with a keyboard, or from a storage medium, or by communication, etc. Specifically, the information can be a source program/COBOL registration collection file, an application information input file, and operation instructions such as a broker-program generation instruction. The source program/COBOL registration collection file is stored in the source-program/COBOL-registration-collection-file storing unit 21, and the application information input file is stored in the application-information-input-file storing unit 22.

The output unit 12 outputs results of processings performed by the control unit 30 to a monitor. For example, the output unit 12 outputs processing error information.

The I/O-control I/F unit 13 controls data transfer among the input unit 11, the output unit 12, the storing unit 20, and the control unit 30.

The storing unit 20 stores data used for processings performed by the control unit 30. The storing unit 20 includes the source-program/COBOL-registration-collection-file storing unit 21, the application-information-input-file storing unit 22, the IDL-file storing unit 23, the working-application-information-input-file storing unit 24, the COBOL-specific-process-source-file storing unit 25, the Bean-source-file storing unit 26, and the Java™-source-file storing unit 27.

The source-program/COBOL-registration-collection-file storing unit 21 stores a source program/COBOL registration collection file input from the input unit 11, which is information required by the broker-program-development supporting apparatus 10 to generate a broker program. As shown in FIG. 3, the source program/COBOL registration collection file includes data type definitions of parameters for a server application, which are described in COBOL by a developer of the server application. For example, SAMPLE-PICX PIC X(10) is a data type definition of a parameter described in COBOL. A parameter name is SAMPLE-PICX and a data type is PIC X(10).

The application-information-input-file storing unit 22 stores an application information input file input from the input unit 11, which is information required by the broker-program-development supporting apparatus 10 to generate a broker program. As shown in FIG. 4, the application information input file includes information described by the developer, such as information on the server application and a method of analyzing the COBOL registration collection. For example, <target name=“apl”/>indicates that the server application name is apl. In FIG. 4, the language for describing the application information input file is an extensible markup language (XML); however, any other language that describes a data structure can be employed, such as a standard generalized mark-up language (SGML).

The IDL-file storing unit 23 stores an IDL file generated by the interface-analysis processing unit 31, which is information required by the broker-program-development supporting apparatus 10 to generate a broker program. As shown in FIG. 5, the IDL file is information expressed in IDL, such as parameter information of the application, an IDL data type, an operation name, and a return value type. For example, long expresses the return value type, and sampleop4 expresses the operation name.

The working-application-information-input-file storing unit 24 stores a working application information input file generated by the interface-analysis processing unit 31, which is information required by the broker-program-development supporting apparatus 10 to generate a broker program. As shown in FIG. 6, the working-application-information-input-file storing unit 24 stores data type conversion information generated by a data-type-conversion-information generating unit 31c (see FIG. 37) in the interface-analysis processing unit 31. For example, <coboldataspec name=“SAMPLE-PIC9” scope=“sampleop4” . . . >indicates a parameter name SAMPLE_PIC9 that is a parameter of an application, and <cobolattribute>PIC 9(6)</cobolattribute> and subsequent descriptions are information required for converting a data type of the application into a data type of COBOL, when the data type of the application is not included among those supported by IDL. In FIG. 6, the language for describing the working application information input file is XML; however, any other language that describes a data structure can be employed, such as SGML.

The COBOL-specific-process-source-file storing unit 25 stores a COBOL-specific-process source file generated by a COBOL-specific-process generating unit 32. As shown in FIGS. 7 to 31, the COBOL-specific-process-source-file storing unit 25 stores a source file described in COBOL. The COBOL-specific-process source file is compiled and linked with a COBOL server application source file created by a developer. Accordingly, a server application is installed in a middleware platform.

The Bean-source-file storing unit 26 stores a Bean source file generated by a Bean generating unit 33. As shown in FIGS. 32 to 34, the Bean-source-file storing unit 26 stores a source file described in Java™. The Bean source file is compiled and linked with a Java™ client application source file created by a developer. Accordingly, a client application is installed in a middleware platform.

The Java™-source-file storing unit 27 stores a Java™ source file generated by the Bean generating unit 33. As shown in FIGS. 35 and 36, the Java™-source-file storing unit 27 stores a source file described in Java™. The Java™ source file is compiled and linked with a Java™ client application source file created by a developer. Accordingly, a client application is installed in a middleware platform.

The control unit 30 controls the broker-program-development supporting apparatus 10 and executes various processings. The control unit 30 includes the interface-analysis processing unit 31, the COBOL-specific-process generating unit 32, and the Bean generating unit 33.

The interface-analysis processing unit 31 generates an IDL file and a working application information input file. Specifically, the interface-analysis processing unit 31 uses a source program/COBOL registration collection file stored in the source-program/COBOL-registration-collection-file storing unit 21 and an application information input file stored in the application-information-input-file storing unit 22 to generate an IDL file and a working application information input file. The IDL file is stored in the IDL-file storing unit 23, and the working application information input file is stored in the working-application-information-input-file storing unit 24.

Referring to FIG. 37, the interface-analysis processing unit 31 includes an IDL-data-type expressing unit 31a, an IDL-file generating unit 31b, the data-type-conversion-information generating unit 31c, and a working-application-information-input-file generating unit 31d.

The IDL-data-type expressing unit 31a expresses, in IDL, an IDL data type that is made to correspond to a data type of an application, based on information on a data type of a parameter for the application. In other words, if the data type of the application is included among those supported by IDL, the corresponding IDL data type is expressed in IDL. On the other hand, if the data type of the application is not included among those supported by IDL, a predetermined IDL data type made to correspond to the data type of the application is expressed in IDL.

For example, when a data type of a parameter for an application described in a source program/COBOL registration collection file is PIC N(10), as shown in FIG. 3, the data type is included among those supported by IDL. Therefore, the corresponding IDL data type wstring is expressed as wstring<10>, as shown in FIG. 5. On the other hand, when a data type of a parameter for an application described in the source program/COBOL registration collection file is PIC 9(9) COMP-3, as shown in FIG. 3, the data type is not included among those supported by IDL. Therefore, an IDL data type, string, is made to correspond to PIC 9(9) COMP-3. Accordingly, the IDL data type is expressed as string<22>, as shown in FIG. 5.

The IDL-file generating unit 31b generates an IDL file expressed in IDL including information required for generating a broker program, from the IDL data type expressed in IDL by the IDL-data-type expressing unit 31a. Specifically, the IDL-file generating unit 31b generates an IDL file from the IDL data type expressed by the IDL-data-type expressing unit 31a and information such as an operation name, a return value type, and a parameter name, described in an application information input file stored in the application-information-input-file storing unit 22. The generated IDL file is stored in the IDL-file storing unit 23. For example, the IDL-file generating unit 31b generates an IDL file from string<22>sample_comp3, which is an IDL data type expressed by the IDL-data-type expressing unit 31a, as shown in FIG. 5, and <operation name=sampleop4>, which is an operation name described in the application information input file, as shown in FIG. 4.

The data-type-conversion-information generating unit 31c generates data type conversion information required for converting a data type of an application into data types of other programming languages, such as COBOL or Java™. For example, when a data type of a server application is PIC 9(6), the data-type-conversion-information generating unit 31c generates data type conversion information indicating that a data type definition in COBOL is PIC 9(6), and a function for conversion according to PIC 9 (external decimal data type) is to be used as a function for data type conversion.

The working-application-information-input-file generating unit 31d generates a working application information input file from the data type conversion information described by the data-type-conversion-information generating unit 31c. Specifically, the working-application-information-input-file generating unit 31d generates a working application information input file from data type conversion information, and other information that cannot be described in the IDL file.

Referring back to FIG. 2, the COBOL-specific-process generating unit 32 generates a broker program from an IDL file and a working application information input file. Specifically, the COBOL-specific-process generating unit 32 generates a COBOL-specific-process source file, which is a broker program, from an IDL file generated by the IDL-file generating unit 31b, and a working application information input file generated by the working-application-information-input-file generating unit 31d. The generated COBOL-specific-process source file is stored in the COBOL-specific-process-source-file storing unit 25.

The Bean generating unit 33 generates a broker program from an IDL file and a working application information input file. Specifically, the Bean generating unit 33 generates a Bean source file and a Java™ source file, which are broker programs, from an IDL file generated by the IDL-file generating unit 31b, and a working application information input file generated by the working-application-information-input-file generating unit 31d. The Bean source file is stored in the Bean-source-file storing unit 26, and the Java™ source file is stored in the Java™-source-file storing unit 27.

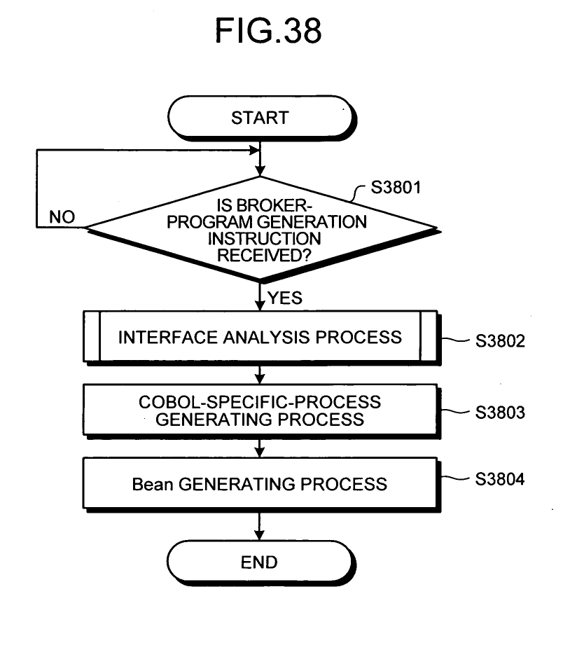

FIG. 38 is a flowchart of a processing performed by the broker-program-development supporting apparatus 10.

When the broker-program-development supporting apparatus 10 receives a broker-program generation instruction for operating the broker-program-development supporting apparatus 10 through the input unit 11 (“Yes” at step S3801), the interface-analysis processing unit 31 generates an IDL file and a working application information input file from the source program/COBOL registration collection file stored in the source-program/COBOL-registration-collection-file storing unit 21 and an application information input file stored in the application-information-input-file storing unit 22, respectively. The IDL file is stored in the IDL-file storing unit 23, and the working application information input file is stored in the working-application-information-input-file storing unit 24 (step S3802).

The COBOL-specific-process generating unit 32 generates a COBOL-specific-process source file, which is a broker program, from the IDL file stored in the IDL-file storing unit 23, and the working application information input file stored in the working-application-information-input-file storing unit 24. The COBOL-specific-process source file is stored in the COBOL-specific-process-source-file storing unit 25 (step S3803).

The Bean generating unit 33 generates a Bean source file and a Java™ source file, which are broker programs, from the IDL file stored in the IDL-file storing unit 23, and the working application information input file stored in the working-application-information-input-file storing unit 24. The Bean source file is stored in the Bean-source-file storing unit 26, and the Java™ source file is stored in the Java™-source-file storing unit 27 (step S3804).

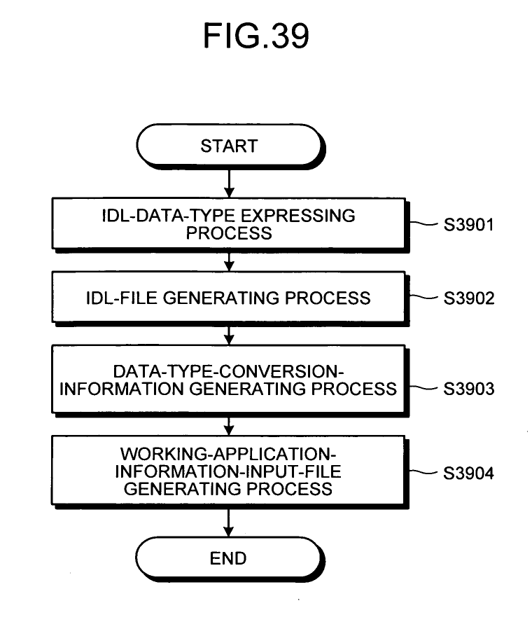

FIG. 39 is a detailed flowchart of an interface analysis process performed at step S3802 in FIG. 38.

The IDL-data-type expressing unit 31a expresses, in IDL, an IDL data type that is made to correspond to a data type of an application, based on information on a data type of a parameter for the application, which is described in the source program/COBOL registration collection file (step S3901).

The IDL-file generating unit 31b generates an IDL file expressed in IDL including information required for generating a broker program, from the data type expressed in IDL by the IDL-data-type expressing unit 31a. The IDL file is stored in the IDL-file storing unit 23 (step S3902).

The data-type-conversion-information generating unit 31c generates data type conversion information required for converting a data type of the application, which is described in the source program/COBOL registration collection file, into a data type of another programming language (step S3903).

The working-application-information-input-file generating unit 31d generates a working application information input file from the data type conversion information described by the data-type-conversion-information generating unit 31c, and other information that cannot be described in the IDL file. The working application information input file is stored in the working-application-information-input-file storing unit 24 (step S3904).

The broker-program-development supporting apparatus 10 generates a COBOL-specific-process source file, a Bean source file, and a Java™ source file from a source program/COBOL registration collection file and an application information input file. However, the broker-program-development supporting apparatus 10 can selectively generate, for example, only the COBOL-specific-process source file or only the Bean source file, and selectively receive a file to be input in accordance with the file to be generated.

According to the first embodiment, when a data type of a parameter for an application is not included among those supported by IDL, the broker-program-development supporting apparatus expresses in IDL, an IDL data type made to correspond to the data type of the application based on information on the data type of the application. The broker-program-development supporting apparatus generates, from the expressed IDL data type, an IDL file that expresses in IDL, information required for generating a broker program. Accordingly, there is a lower chance that the developer will make a definition error, than with the conventional method in which the developer needs to prepare a special correspondence table by defining an IDL data type according to newly set description rules. Moreover, the developer does not need to manage special correspondence tables prepared for different applications. Thus, the amount of work required of the developer for creating a broker program is reduced, when a data type of a parameter for an application is not included among those supported by IDL.

Furthermore, according to the first embodiment, the broker-program-development supporting apparatus generates data type conversion information required for converting a data type of an application into a data type of another programming language, and a broker program is generated from the generated IDL file and the data type conversion information. Therefore, when a data type of a parameter for an application is not included among those supported by IDL, the data type of the application can be converted into a data type of another programming language. Accordingly, a broker program that operates properly can be generated.

A second embodiment according to the present invention is described as follows. According to the first embodiment, the server application is described in COBOL, and the client application is described in Java™. However, the applications can be described in other programming languages. For example, the server application can be described in C when the client application is described in Java™. In another example, when the server application is described in COBOL, the client application can be described C.

According to the first embodiment, interaction between the server application and the client application is realized. However, interaction between plural server applications, or interaction among a plurality of applications of different processing systems, such as an asynchronous system, can be realized.

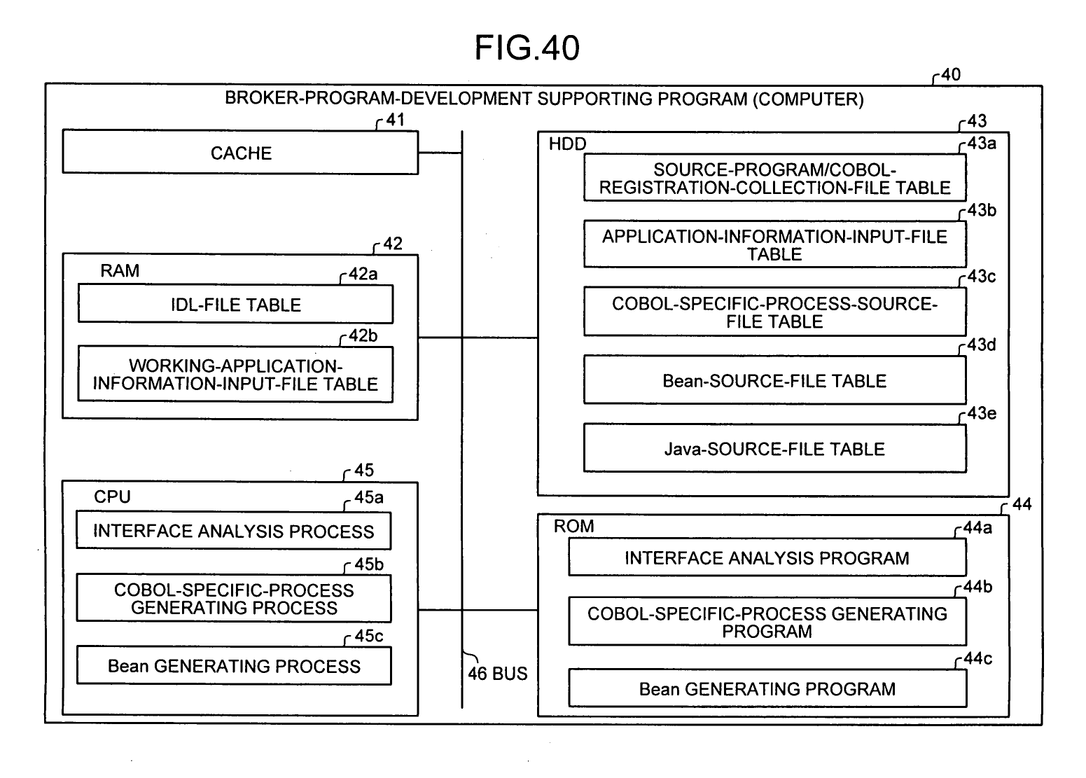

The processings performed according to the first embodiment can be implemented on a computer system such as a personal computer or a work station by executing a computer program. FIG. 40 is a block diagram of a broker-program-development supporting program (computer) 40 according to the second embodiment. The broker-program-development supporting program (computer) 40 has the same functions as the first embodiment. Overlapping descriptions are omitted.

The broker-program-development supporting program (computer) 40 includes a cache 41, a random access memory (RAM) 42, a hard disk drive (HDD) 43, a read-only memory (ROM) 44, a central processing unit (CPU) 45, and a bus 46 for connecting these units. The ROM 44 includes an interface-analysis processing program 44a, a COBOL-specific-process generating program 44b, and a Bean generating program 44c.

The CPU 45 reads and executes the programs in the ROM 44. Specifically, the interface-analysis processing program 44a, the COBOL-specific-process generating program 44b, and the Bean generating program 44c become an interface analysis process 45a, a COBOL-specific-process generating process 45b, and a Bean generating process 45c, respectively. The interface analysis process 45a, the COBOL-specific-process generating process 45b, and the Bean generating process 45c have the same functions as the interface-analysis processing unit 31, the COBOL-specific-process generating unit 32, and the Bean generating unit 33 of the first embodiment, respectively.

The HDD 43 includes a source-program/COBOL-registration-collection-file table 43a, an application-information-input-file table 43b, a COBOL-specific-process-source-file table 43c, a Bean-source-file table 43d, and a Java™-source-file table 43e. These tables have the same functions as the source-program/COBOL-registration-collection-file storing unit 21, the application-information-input-file storing unit 22, the COBOL-specific-process-source-file storing unit 25, the Bean-source-file storing unit 26, and the Java™-source-file storing unit 27 of the first embodiment, respectively.

The RAM 42 includes an IDL-file table 42a and a working-application-information-input-file table 42b, which have the same functions as the IDL-file storing unit 23 and the working-application-information-input-file storing unit 24 of the first embodiment, respectively.

The interface-analysis processing program 44a, the COBOL-specific-process generating program 44b, and the Bean generating program 44c do not necessarily have to be stored in the ROM 44. The programs can be stored in transportable storage media inserted in the broker-program-development supporting program (computer) 40 such as a flexible disk (FD), a compact disc read only memory (CD-ROM), a magneto-optical (MO) disk, a digital versatile disk (DVD), and an integrated circuit (IC) card. The programs can be stored in fixed storage media, installed in or externally attached to the broker-program-development supporting program (computer) 40, such as a HDD. The programs can be stored in communication media such as a database in another computer system or server connected to the broker-program-development supporting program (computer) 40 through a public line, the Internet, a local area network (LAN), a wide area network (WAN), and so forth.

All the automatic processes explained in the present embodiment can be, entirely or in part, carried out manually. Similarly, all the manual processes explained in the present embodiment can be entirely or in part carried out automatically by a known method. The sequence of processes, the sequence of controls, specific names, and data including various parameters can be changed as required unless otherwise specified.

The constituent elements of the devices illustrated are merely conceptual and may not necessarily physically resemble the structures shown in the drawings. For instance, the devices need not necessarily have the structure that is illustrated. The devices as a whole or in parts can be broken down or integrated either functionally or physically in accordance with the load or how the devices are to be used. The process functions performed by the apparatus are entirely or partially realized by the CPU 45 or a program executed by the CPU 45 or by a hardware using wired logic.

According to an embodiment of the present invention, there is a lower chance that the developer will make a definition error, than with the conventional method in which the developer needs to prepare a special correspondence table by defining an IDL data type according to newly set description rules. Moreover, the developer does not need to manage special correspondence tables prepared for different applications. Thus, the amount of work required of the developer for creating a broker program is reduced, when a data type of a parameter for an application is not included among those supported by IDL.

Furthermore, when a data type of a parameter for an application is not included among those supported by IDL, the data type of the application can be converted into a data type of another programming language. Accordingly, a broker program that operates properly can be generated.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for supporting development of a broker program configured to be installed in a middleware platform that realizes an interaction between plural applications described in various programming languages, the broker program brokers the interaction between the applications, the apparatus comprising:
a data-type expressing unit that expresses, when a data type of a parameter for the application is out of a range of data type supported by an interface definition language, a predetermined data type of the interface definition language corresponding to the data type of the application in the interface definition language, based on information on the data type of the application; and
a file generating unit that generates an interface-definition-language file in which information required for generating the broker program is expressed in the interface definition language using the data type of the interface definition language expressed by the data-type expressing unit.

2. The apparatus according to claim 1, further comprising:
an information generating unit that generates data-type conversion information required for converting the data type of the application into a data type in the various programming languages; and
a program generating unit that generates the broker program using the interface-definition-language file generated by the file generating unit and the data-type conversion information generated by the information generating unit.

3. A method of supporting development of a broker program configured to be installed in a middleware platform that realizes an interaction between plural applications described in various programming languages, the broker program brokers the interaction between the applications, the method comprising:
data-type expressing including expressing, when a data type of a parameter for the application is out of a range of data type supported by an interface definition language, a predetermined data type of the interface definition language corresponding to the data type of the application in the interface definition language, based on information on the data type of the application; and
file generating including generating an interface-definition-language file in which information required for generating the broker program is expressed in the interface definition language using the data type of the interface definition language expressed at the data-type expressing.

4. The method according to claim 3, further comprising:
information generating including generating data-type conversion information required for converting the data type of the application into a data type in the various programming languages; and
program generating including generating the broker program using the interface-definition-language file generated at the file generating and the data-type conversion information generated at the information generating.

5. A computer-readable recording medium that stores a computer program for supporting development of a broker program configured to be installed in a middleware platform that realizes an interaction between plural applications described in various programming languages, the broker program brokers the interaction between the applications, wherein
the computer program causes a computer to execute:
data-type expressing including expressing, when a data type of a parameter for the application is out of a range of data type supported by an interface definition language, a predetermined data type of the interface definition language corresponding to the data type of the application in the interface definition language, based on information on the data type of the application; and
file generating including generating an interface-definition-language file in which information required for generating the broker program is expressed in the interface definition language using the data type of the interface definition language expressed at the data-type expressing.

6. The computer-readable recording medium according to claim 5, wherein
the computer program further causes the computer to execute:
information generating including generating data-type conversion information required for converting the data type of the application into a data type in the various programming languages; and
program generating including generating the broker program using the interface-definition-language file generated at the file generating and the data-type conversion information generated at the information generating.
